(19) United States
(12) Patent Application Publication
(10) Pub. No.: US 2022/0004903 A1
(43) Pub. Date: Jan. 6, 2022

(54) SYSTEMS AND METHODS OF DETERMINING ELIGIBILITY OF STUDENT ATHLETES

(71) Applicant: Eligibility Wizard, Inc., Beverly Hills, CA (US)

(72) Inventors: Carl Peter Torsson, Stevenson Ranch, CA (US); Michael Patrick O'Rafferty, Okanagan Falls (CA)

(21) Appl. No.: 17/367,139

(22) Filed: Jul. 2, 2021

Related U.S. Application Data
(60) Provisional application No. 63/048,106, filed on Jul. 4, 2020.

(51) Int. Cl. G06N 5/04; G06Q 50/20; G06Q 10/10; G06N 20/00

(52) U.S. Cl. CPC G06N 5/04; G06N 20/00; G06Q 10/10; G06Q 50/205

(57) ABSTRACT

Systems and methods for determining eligibility for, e.g., collegiate athletics, recommending actions and classes to fulfill requirements, and providing checklists, charts, and recommendations in one or more user interfaces. The system may store, e.g., in storage equipment, eligibility requirements for athlete candidates from a governing body that defines an eligibility state, and store course information from one or more high schools. The system may receive, over a communications network, academic information for an athlete candidate. The system may generate, using processing circuitry, a profile for the athlete candidate using the course information, and the academic information. The system may generate the profile for the athlete candidate using the eligibility requirements. The eligibility requirements may comprise requirements from one or more educational institutions (e.g., stricter requirements). The system may determine a difference in a current state of the athlete candidate and the eligibility state based on the profile. The system may determine at least one recommendation for allowing the athlete candidate to achieve the eligibility state and provide, over the communications network, the at least one recommendation. The system may generate for display a graphical user interface comprising the at least one recommendation in a first section and a portion of the profile in a second section. In some embodiments, the system may provide the recommendation and/or at least a portion of the profile via a wholesale user interface.

### RELATED APPLICATIONS

This application claims priority to U.S. Provisional Patent Application No. 63/048,106, filed Jul. 4, 2020, the disclosure of which is incorporated herein by reference in its entirety.

### BACKGROUND OF THE DISCLOSURE

The present disclosure relates generally to the field of interfaces. More particularly, the disclosure describes herein relates to systems and methods for providing a user interface comprising information about student-athlete eligibility and recommendations to gain eligibility.

### SUMMARY OF THE DISCLOSURE

The ability to participate in collegiate athletics depends on academic qualifications as a high school student, and the academic requirements are not always easy to discern and navigate. The National Collegiate Athletic Association (the “NCAA”) Eligibility Center evaluates prospective college athletes under a set of rules related to athletic status and academic performance. The athletic status is reviewed when an athlete applies for final certification with the NCAA during their final semester of high school. Failing to meet the eligibility requirements may mean a loss of opportunity to participate in college as a student-athlete—and potentially loss of opportunities for monetary scholarships or enrollment at one of the many great NCAA colleges. Preparing for the NCAA's eligibility evaluation can be a high stakes game and may be dependent on an athlete working through the eligibility requirements throughout his or her high school years.

Finding the NCAA eligibility requirements is a first challenge. The NCAA publicizes rules that aspiring college athletes must meet while in high school prior to enrolling at a NCAA college. The NCAA has made general information public which requires each athlete or the parents of such athlete to be an expert as most athletes find themselves confused and inexperienced. The NCAA will allow an aspiring athlete to ask specific questions, but their answers are typically generic, and must be asked by an athlete or his/her parents. The NCAA representatives rarely guide an athlete proactively and rarely provide comfort after the fact. These problems have attracted many self-proclaimed advisors and service providers to athletes—consultants who are often focused on athletic ability of an athlete and typically lack expertise necessary to help guide an athlete appropriately towards collegiate eligibility. Additionally, the NCAA has strict rules against an athlete hiring an agent, e.g., to provide such services, and such relationship with an agent may trigger ineligibility for an athlete. Teams, coaches, leagues, administrators, counselors, and even the NCAA collegiate athletic departments and sports programs often spend large amounts of time (and resources) trying to proactively make sense of an athlete's eligibility status. For instance, what football program would want to spend time recruiting a linebacker who has not taken the correct amount of math classes during his time in high school? Hopefully the linebacker earns eligibility and finds a college but learning of ineligibility too late in the recruiting timeline can be costly for all parties involved. To make things worse, the NCAA will only actually review an athlete's candidacy for eligibility when he/she has submitted the final transcripts to the NCAA and a NCAA program has expressed interest to the NCAA that an athlete in question wants to enroll at their respective schools. Accordingly, an improved user interface is needed to determine eligibility of a prospective collegiate athlete while in high school.

An Eligibility Wizard application may be considered a proactive, customized turnkey solution to an athlete seeking eligibility. By using their own transcripts and Test Scores, Eligibility Wizard can give an athlete a thorough understanding of their athletic status based on their academic standing against every required NCAA rule—at any point while in high school. Eligibility Wizard may include a forecast explaining performance requirements needed by an athlete to meet minimum requirements to present a thorough explanation of what course selections may be available to each student, as well as how each course decision may affect each student in terms of eligibility. Eligibility Wizard may also streamline communication with third parties and notify an athlete when a deadline is due, e.g., either for Eligibility Wizard or as required by the NCAA. In short, an athlete will not need any other service and will only spend a fraction of their time to gain a deep understanding of the path to eligibility in the NCAA—and why it needs to be done. Of course, the Eligibility Wizard application does not replace the requirements of the NCAA at this time—which, in the end, is completed by NCAA colleges and the athlete—but it will ensure an athlete is in full control of everything eligibility related.

Interested third parties also suffer in guessing the expected eligibility status of athletes. There are many kinds of third parties. For instance, high school teams and leagues want to make sure their athletes don't suffer academically by partaking in their competition, so they may help guide an athlete towards eligibility. Similarly, club teams and teams who are members of Amateur Athletic Union (AAU) may be similarly positioned. Eligibility Wizard, used by a coach and/or manager, may reduce the need for their intervention, as it can help organize tasks, save time, and become an integral part of their business operations by boosting efficiencies and improving results. Talent agencies, when permitted by rules of amateurism, may guide athletes towards eligibility, but agents may also find themselves suffering similar in a manner similar to high school teams/leagues. One mistake by an agency on behalf of a client who becomes ineligible could suffer dire consequences to the entire agency. Likewise, NCAA colleges may benefit from Eligibility Wizard as they spend millions of dollars recruiting players annually. The athletic performance ability is at the forefront of every scout recruiting a player, yet many college coaches and scouts may find themselves recruiting in vain as academic performance of an athlete unwittingly falls short of NCAA requirements. NCAA colleges certainly waste time and money on athletes who may always fall short in (or may not be interested in) qualifying as eligible. Eligibility Wizard will enable NCAA colleges to quickly assess the likelihood of an athlete becoming eligible or, in some instance, an athlete can be guided seamlessly by Eligibility Wizard towards eligibility. Eligibility Wizard is a turnkey solution for third parties when managing potential athletes as it offers academic transparency, guidance, and practically instant solutions. The cost savings for third parties are substantial as the application minimizes a major portion of a vital process most scouts, agents, teams and/or leagues are not interested in managing. Everyone can be an expert at what they want to focus on the most—e.g., athletic performance of an athlete and the athletic needs of the NCAA college recruiting athletes.

The academic NCAA rules that each athlete must meet are all determined while an athlete is in high school. The rules aim at forcing an athlete to prepare for academic success while at an NCAA college. For this reason, the NCAA has evaluated high schools in North America and assigned certain classes, but not all, that are available at each high school and regarded them as Core Courses. Each athlete must complete a satisfying amount of these classes, within a desired time-period, meeting minimum grade guidelines, within certain subject categories in certain amounts and receiving an overall performance GPA that meets a minimum requirement and a Sliding Scale requirement determined by a Test Score for a standardized test such as the ACT and/or SAT test. To make it more complicated, the NCAA allows an athlete to utilize a Superscore when calculating the Sliding Scale requirement, but it is different from the regular overall score referred to when quoting the SAT and/or ACT score. The NCAA has instead decided to use component scores in aggregate which could be higher than the actual total score when comparing to the Sliding Scale requirement. Also, timing of class completion is a very important part of eligibility. Students must take certain classes before the commencement of their fourth year in high school. Thus, students who repeat a grade (e.g., Freshman, Sophomore, Junior, Senior), for example, find themselves thinking they are great students, but the timing has caused eligibility to be compromised or impossible.

Eligibility Wizard will be able to take each individual athlete, apply the information only relevant to such student and create a complete understanding of what that athlete needs to do, when to do it, how well to do it, where to do it and how to overcome shortcomings before they become too late.

Eligibility Wizard does not replace the NCAA to an athlete. There are certain requirements an athlete must comply with in order to become eligible. Eligibility Wizard will show an athlete how and when to meet each of these requirements, but the student must take action outside Eligibility Wizard to satisfy these requirements by the NCAA. One example is that an athlete must create a Certification Account with the NCAA to be able to receive a NCAA identification number. This NCAA identification number is used by the NCAA college compiling all the required documents in order to evaluate an athlete. An athlete must also submit all the information to the NCAA using specific instructions and people. All transcripts must be sent to the NCAA by high school counselors, all Test Scores must be sent directly to the NCAA by the test center (e.g., an athlete is instructed to enter a code of “9999” when taking the test to automate it). In short, the NCAA wants to eliminate as much contact with the actual athlete or his/her parents as possible and only deal with entities. The only information an athlete provides to the NCAA is contact information and answering a questionnaire about athletic eligibility. Eligibility Wizard will give control back to an athlete and provide comfort and less stress when seeking eligibility.

Eligibility Wizard will populate the Core Classes that are relevant to each athlete's scenario so that all that is needed is a transcript and an athlete will be able to find all the answers related to his/her path towards eligibility. Whether a grade (e.g., Freshman, Sophomore, Junior, Senior) has been repeated, a class has been repeated, multiple schools have been attended or classes have been duplicated, Eligibility Wizard will provide the answers. Each student will choose the high schools attended, select the classes taken at each school, input the grades received in each class and append what year each class was completed. If an athlete is graduated, the final transcript will provide the student with a snapshot that will indicate whether an athlete has met each rule established by the NCAA and, if a rule has not been met, a description will notify an athlete what is missing and whether there is a course of action to be taken that can overcome the problem. In addition, any athlete who is not yet graduated can utilize at least the following features: (a) a “dashboard” that shows the current status toward each NCAA rule, (b) a “roadmap” listing all the available NCAA Core Classes available at the school to be attended next year, (c) a “forecast” feature that will show what performance is needed going forward to meet minimum requirements, and (d) and an “assistant” that can notify an athlete of deadlines, necessary course of action, and other steps to meet requirements.

Some embodiments may incorporate a dashboard. A dashboard may be a snapshot of an athlete's performance towards each NCAA rule at the current time. A dashboard may indicate a status for several requirements, including, but not limited to, the following established NCAA rules: a minimum requirement of four completed English classes, a minimum requirement of three completed Math classes, a minimum requirement of two completed Natural/Physical Science classes, a minimum requirement of two completed Social Science classes, a minimum requirement of one completed Additional Core class that must be in the subjects of English, Math or Natural/Physical Science, a minimum requirement of four completed Additional Core classes that can be in the subject categories of Additional Core, English, Math, Natural/Physical Science, Social Science, a minimum of one Natural/Physical Class that incorporates a laboratory aspect (if offered), a minimum of ten core classes must be completed before an athlete's fourth year commences and seven of those classes must be in the subject categories of English, Math and Natural/Physical Science, a minimum GPA of 2.3, and/or a minimum SAT and/or ACT Test Score in accordance with a “Sliding Scale” requirement published by the NCAA. In some embodiments, a dashboard may show a minimum Test Score as dependent on an athlete's final GPA across the NCAA Core classes allowed.

Some embodiments may incorporate a roadmap. A roadmap may comprise a listing of each approved Core Class allowed at a secondary school an athlete expects to attend next semester/year. Typically, this may not be a feature used by athletes who have already graduated but may be very useful as proactive guide. For instance, a roadmap may display, e.g., (i) each available class that an athlete can take in the future, (ii) suggested credit value by class, (iii) an average grade received by each athlete in each class, and/or (iv) any warnings related to the class. In some embodiments, a roadmap may provide a list of all available classes that an athlete can take in the future at a selected secondary school (e.g., high school).

In some embodiments, a roadmap may provide a suggested credit value by class. The NCAA will, at times and in seemingly random ways, publish very confusing data that may indicate a class might (or might not) only award an athlete with a partial credit. Eligibility Wizard may suggest, e.g., based on up-to-date credit information per the publication by the NCAA, a recommended course of action to take to ensure the correct credits are applied in each case. Some embodiments may incorporate a way for athletes to leave notes or messages for other athletes who may be in the same situation in the future. If an athlete follows the suggested course of action, the credit value can be amended to correctly amend an athlete's case. Over time, some embodiments may track changes made by athletes so that Eligibility Wizard may indicate the statistical success rate of each action taken, if different, in relation to each class.

In some embodiments, a roadmap may provide an average grade received by each athlete in each class. Some embodiments may allow a filter, e.g., by sport, year, grade-level, etc., as well. A sport filter for average grade may be important as some sports may be more intense in the spring rather than in the autumn (or vice versa) and more intense classes can be scheduled to avoid times a may be at its peak commitment rate. For instance, a dashboard may indicate baseball players (spring) perform better in a specific class in the first semester (autumn), while soccer players (autumn) appear to earn lower grades.

In some embodiments, a roadmap may provide any warnings related to a class. For instance, warning may include one or more of the following: a selected class awards partial credit if taken with another class as specified, a selected class will only be allowed until a certain year or date is concluded, a certain class has a partial credit if multiple classes are taken within a certain subject (e.g., usually debate, communications, history or other smaller subject categories), a selected class can only be taken in a certain grade-level (e.g., Freshman, Sophomore, Junior, Senior), otherwise it is not eligible, a certain class may be awarded a higher grade due to it being labeled as “Advanced,” “Honors,” or other degree of higher difficulty.

Some embodiments may incorporate a forecast for athletes to identify missing requirements prior to graduation. Generally, the NCAA has static and variable performance measures that must be met upon graduation. Eligibility Wizard will show the current status of each of these performance measures, but the Forecast may display information about how to meet these requirements in the future, e.g., if an athlete is using Eligibility Wizard before graduation but still has the ability to add Core Courses in the future. A forecast may be valuable because, for example, a forecast may provide a current GPA and/or what GPA is needed each term (e.g., semester, quarter, trimester, etc.) going forward to meet and/or exceed the minimum GPA requirement (e.g., 2.3) for a full qualifier and/or the minimum GPA requirement for a “redshirt” (2.0). A forecast may provide a current ACT and/or SAT score (e.g., if available) and a Test Score needed to meet the “Sliding Scale” requirement given a current GPA of the athlete-in-question. In some embodiments, multiple SAT scores may be input, and Eligibility Wizard will “Superscore” the tests as allowed by the NCAA for a forecast. In some embodiments, multiple ACT scores may be input, and Eligibility Wizard will “Superscore” the tests as allowed by the NCAA for a forecast. A forecast may provide a current GPA needed to meet the Sliding Scale requirement of the current SAT test (e.g., if available). A forecast may provide a current GPA needed to meet the Sliding Scale requirement of the current ACT test (e.g., if available).

Some embodiments may incorporate an “Assistant” to help guide input from an athlete. Eligibility Wizard may guide an athlete via a feature called an Assistant, to complete certain tasks. In some embodiments, an Assistant may comprise one or more checklists and notifications or prompts to complete one or more items from the checklists. Whether an athlete decides to use Eligibility Wizard or not, the requirements of the NCAA are still necessary to be completed concurrent to using Eligibility Wizard. An Assistant feature can help manage tasks such as inputting classes, grades, and scores. For instance, an Assistant may guide and prompt for tasks such as, but not limited to, uploading the latest transcripts to Eligibility Wizard each year, notifying a counselor of an athlete's high schools to submit transcripts to the NCAA when required, inserting a correct code when taking an ACT or SAT test (e.g., so the scores are automatically sent to the NCAA), updating latest classes to Eligibility Wizard in order to refresh the Dashboard, Roadmap and Forecast, notifying an athlete when (and why) to create a Profile account with the NCAA, notifying an athlete when (and why) to create a Certification Account with the NCAA, notifying an athlete when and why it is allowed to sign a National Letter of Intent (NLI) in a respective sport in accordance with NCAA rules, notifying an athlete when a NCAA program is requesting data from Eligibility Wizard for review (e.g., scouting). Notifying an athlete when a NCAA program is reviewing the profile from Eligibility Wizard (e.g., prospect), and enabling communication and direct submissions to NCAA programs (and representatives) that may be otherwise constrained by the recruitment rules established by the NCAA.

Some embodiments may incorporate third-party access (e.g., a recruiting coach or institution) also called a “Wholesale” platform. For instance, some embodiments may include a feature for one or more third parties such as institutions, admissions representatives, coaches, scouts, recruiters, managers, agents, athletic department representatives, and/or other interested parties to provide a turnkey solution to recruitment and management of athletes through the process towards achieving eligibility. Wholesale may allow features including, but not limited to, communication with an athlete via chat and email, communication about an athlete between recruiters/managers to ensure action is taken by the right person at the right time, providing assistance to an athlete inserting data and/or uploading documents, tracking an athlete's progress towards eligibility, automated notifications to an athlete to minimize any need for handholding, automated notifications to the third party (e.g., Wholesale entity) to ensure nothing is missed in terms of meeting deadlines, uploading documents, completing inputs and/or completing specific tasks, customized notifications to an athlete or other Wholesale users created by the Wholesale user to meet specific deadlines, upload documents, completing inputs and/or completing specific tasks, creating prospect lists by department (e.g., add athletes, delete athletes, edit athletes), and sharing prospect lists between associated Wholesale users. For instance, a Wholesale platform may comprise a three-tier user-level controls such as Admin, Department, and users. Admin, for example, may have full access to all levels of controls and can add and/or delete Departments and users. An Admin-level user may act as a financial and business contact person responsible for all costs and administrative needs of the Wholesale entity needs. A Department-level user may act as a specific focus of athletes. For example, each institution (e.g., college) may have, but is not limited to, a soccer, volleyball, and football department. Each department likely recruits a specific type of athlete—and each athlete is likely of no interest to another Department. Each Department may include one or several people who have rights to add and/or delete athletes from recruiting lists, edit athlete inputs, and add/delete users. In some cases, users may be within each department and are usually comprised of staff specific to each department, such as, but not limited to, coaches and/or scouts. The users are usually the face of the institution for an athlete and perform most of the daily, weekly, annual contacts with each athlete. Users will have the ability to manage athletes, e.g., in recruiting lists, and provide input. In some embodiments, users generally will have no capability to add/delete athletes from the prospect list.

Some embodiments may incorporate a scouting profile, e.g., the “Total Scout.” An athlete can decide to add a Total Scout where an athlete will be able to create a sport specific profile. For instance, a profile may include (but not limited to) highlight video reels, URL links to team websites or similar, game footage and film, contact information to third parties, third party endorsements, reviews, URL to articles, upload of documents (e.g., articles, achievements etc.), schedules of events an athlete will attend (e.g., feeding “Instant Scout” below), résumé of achievements in the sports, awards, notable victories, leadership acknowledgments (being captain). Some embodiments using a scouting profile may include testing metrics of an athlete for purposes of competitive advantage such as strength, endurance, explosiveness, agility, flexibility, body composition and cognitive abilities. Some embodiments using a scouting profile may include statistics such as personal best at competitions, goals scored, highest jump etc., as well as trending statistics. Some embodiments may include a personal profile with height, weight, BMI, and other personal attributes.

Some embodiments may incorporate a scouting matching feature called, e.g., the “Instant Scout.” A purpose of the Instant Scout would be to allow a user of the Wholesale platform to recruit an athlete on location. For instance, some embodiments may notify a Wholesale user when athletes, e.g., an athlete on a prospect list, may be in a geographic area. If an athlete has enabled the Instant Scout feature and updated their schedules with dates and locations of events to attend. An athlete may be tracked at an event when, e.g., an athlete uploads the intention to attend an event on a specific date at a specific location, a Wholesale user may be notified before the event and as the event commences then, within a specific timeframe prior to the event, an athlete will enable location-sharing device (e.g., smartphone) enabling the Wholesale user to see their location. In some embodiments, an athlete may receive a notification with one or more Wholesale users in attendance at the concurrent event. This may depend, for instance, on whether the Wholesale user making themselves available for such tracking at such times. In some embodiments, a Wholesale user will not only be able to see athletes on their prospect list, but also be able to search other athletes who have enabled Instant Scout mode. Instant Scout may immediately display, via Wholesale platform, each athlete's progress towards eligibility, such as academic and athletic eligibility status, as well as some or all information inserted into the scouting portal. In some embodiments, a Wholesale user will be able to notify an athlete of their attendance and request access to a profile, academic information, transcripts, and other academic and athletic information needed to update their Prospect list.

Some embodiments may incorporate an automated transcript capture feature, e.g., “Pic to Perfect.” For instance, by utilizing a camera-enabled device such as a smartphone or digital camera, Eligibility Wizard may perform (or access), e.g., text recognition such as Optical Character Recognition (or “OCR”), conversion of a transcript image into text, capture of, e.g., class titles, class grades received, years/dates each class was completed, school(s) attended, years/grade-levels (e.g., Freshman, Sophomore, Junior, Senior) completed, matching transcript information with the NCAA database to only consider the approved courses for input, consideration of any subjective or relational conditions that may alter the credit input per class, submission of gathered information for athlete review, and/or enabling submission(s) by athlete to the engine for processing and output production. Some embodiments may use machine learning and/or artificial intelligence to facilitate such functions. This functionality and machine learning may replace any need for an athlete to input the academic information by hand, e.g., which may be the most difficult and time-consuming part of the eligibility determination process.

Some embodiments may incorporate athlete ranking. Eligibility Wizard may feature a comparison of metrics regarding athletic abilities, e.g., within their specific sports that combine statistical results. Some embodiments may use a weighting of such results depending on the importance of the event (e.g., such as a scrimmage-level versus competing in a state final event), as well as an impact of the statistic (e.g., such as a game-winning goal in a scrimmage vs. game-winning score in a championship). Some embodiments may allow Wholesale users to filter their needs to populate lists of athletes ranked by such desire. For example, a Wholesale user may be in search of a player who is over 6′5″ and heavier than 225 pounds who has more than 10 tackles a playoff game. Such filters may be customized per sport and/or athletic performance measure components that are applicable. For instance, a hockey example is described in more detail below. The current marketplace does have statistical comparisons, but they are rarely measurable between teams and/or athletes. Some teams play a tougher schedule and has deeper rosters than others. Some players play against athletes who are significantly older than other athletes. This makes the comparative measures very difficult to predict. By combining the performance with these external influences, the key performance metrics of athletes will become much more transparent and relevant. The data input will be compiled by artificial intelligence captured via visual medium. The data is populated in our database and subsequently processed and manipulated towards a desired output via algorithms.

In some embodiments, an athlete ranking may be determined by a multiplier used to boost performance results when competing against superior (or inferior) opponents. For example, if an athlete is competing against opponents two years older and at the same level as an athlete, the multiplier will be applied to generate a comparable performance value given the situation. In some cases, such as when an athlete competes against athletes who are two years older, but the opponents compete at a level lower than the athlete, the performance measure may be equal. In some embodiments, comparability may be generated based on processing of (massive) collected data.

By way of a non-limiting example, some embodiments may incorporate athlete ranking for ice hockey. In some embodiments, measurements like average shot velocity or rebound deflection per degrees on shots received by a goalie on the penalty kill may be factored into a ranking for an ice hockey athlete. In some embodiments, certain metrics may be weighted higher or given a higher multiplier such as, goals scored in the last 5 minutes of a close game (e.g., 2 goal difference or less), blocked shots on penalty kills in playoff games may be weighted higher, and/or number of shots taken on power plays in the last 5 minutes of a game. Some embodiments may incorporate (time of) (time of) possession of a puck against teams with an average age 2 years older than an athlete at a different weight (e.g., two-times) than possession of a puck against teams with an average age similar to the athlete.

Some embodiments may incorporate a match-making feature for student-athletes and institutions called, e.g., “Best Fit.” Some embodiments may evaluate the academic performance of an athlete and match it with NCAA colleges and athletic programs that may Best Fit the qualities of an athlete.

Some embodiments may incorporate features to allow institutions to set more stringent requirements for potential student-athlete applicants, e.g., a “Goal Setter” mode. For instance, certain conferences or collegiate athletic programs may require a higher GPA or a higher standardized test score. Some embodiments may allow an athlete to specify NCAA college that may have stricter academic requirements than those set by the NCAA. By selecting the favorite NCAA colleges, some embodiments may include the stricter requirements as an alternative or added display to indicate what academic performance needs an athlete must meet to satisfy requirements of selected colleges.

Some embodiments may incorporate, e.g., a “Superscore Calculator” to determine a correct (e.g., best) standardized test score from among several results or partial results of standardized tests. Some embodiments may allow an athlete to simply input ACT and/or SAT scores (or any other standardized test scores) individually and Eligibility Wizard will aggregate the best scores across all categories to be applied against the Sliding Scale requirement. The Sliding Scale requirement is one of the most confusing and difficult requirements and a Superscore may allow easier passage. athletes struggle identifying their personalized minimums for eligibility. For instance, an athlete with a solid GPA and inferior standardized test-taking skills may discover the personalized minimum score(s) for eligibility and opportunities may arise.

As disclosed herein, systems and methods may determine eligibility for, e.g., collegiate athletics, recommend actions and high school classes to fulfill requirements, and provide checklists, charts, and recommendations in one or more user interfaces. In some embodiments, the system may store, e.g., in storage equipment, eligibility requirements for athlete candidates from a governing body that defines an eligibility state, and store, in the storage equipment, course information from one or more high schools. The system may receive, over a communications network, academic information for an athlete candidate. The system may generate, using processing circuitry, a profile for the athlete candidate using the course information, and the academic information. The system may generate the profile for the athlete candidate using the eligibility requirements. The eligibility requirements may comprise requirements from one or more educational institutions (e.g., stricter requirements). The system may determine a difference in a current state of the athlete candidate and the eligibility state based on the profile. The system may determine at least one recommendation for allowing the athlete candidate to achieve the eligibility state and provide, over the communications network, the at least one recommendation.

In some embodiments, the system may generate for display a graphical user interface comprising the at least one recommendation in a first section and a portion of the profile in a second section. In some embodiments, the system may provide the recommendation and/or at least a portion of the profile via a wholesale user interface.

In some embodiments, the system may determine whether the athlete candidate meets the requirements from at least one of the one or more educational institutions based on the profile and, as a result, may provide data from the profile to at least one of the one or more educational institutions via a coach's portal or an admissions portal.

In some embodiments, the system may determine the at least one recommendation using a trained machine learning model to generate data indicative of courses for the athlete candidate to achieve the eligibility state. A trained machine learning model may generate data indicative of courses for the athlete candidate further based on at least one of the following criteria associated with the athlete candidate: a school, a location, a grade-level, a semester, a sport, and one or more rules associated with the school. The system may determine the at least one recommendation using a trained machine learning model to generate data indicative of courses for the athlete candidate to achieve a minimum grade point average. A trained machine learning model may be trained to receive information about a plurality of completed courses, grades for each of the plurality of completed courses, credits associated with each of plurality of completed, and at least some other information from the profile as input, and output one or more courses that would help achieve a desired grade point average.

In some embodiments, the system may determine the at least one recommendation using a data analytics technique to generate data indicative of courses for the athlete candidate to achieve the eligibility state. Data analytics techniques may process profiles of a plurality of other students to identify similar profiles of the athlete candidate and to determine which courses taken by students associated with the similar profiles resulted in grades that would help that would achieve the eligibility state.

In some embodiments, the eligibility requirements may include a plurality of standardized test scores each with a corresponding grade point average, the academic information comprises a candidate standardized test score. The system may determine the at least one recommendation by comparing the candidate standardized test score to the plurality of standardized test scores.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 depicts a diagram of an illustrative user experience, in accordance with some embodiments of the disclosure;

FIG. 2 depicts a diagram of an illustrative user experience, in accordance with some embodiments of the disclosure;

FIG. 3 is a diagram of an illustrative user experience, in accordance with some embodiments of the disclosure;

FIG. 4A is a diagram of an illustrative user experience, in accordance with some embodiments of the disclosure;

FIG. 4B is a diagram of an illustrative user experience subsequent to FIG. 5A, in accordance with some embodiments of the disclosure;

FIG. 5A is a diagram of an illustrative control feature, in accordance with some embodiments of the disclosure;

FIG. 5B is a diagram of an illustrative control feature further expanded from FIG. 5A, in accordance with some embodiments of the disclosure;

FIG. 5C depicts a diagram of an illustration of the information output ability of a user related to the control features illustrated in FIG. 5A and FIG. 5B, in accordance with some embodiments of the disclosure;

FIG. 6A depicts an illustrative flow chart of a process for providing a recommendation for an athlete to achieve eligibility, in accordance with some embodiments of the disclosure;

FIG. 6B depicts an illustrative flow diagram of a process for training a machine learning model, in accordance with some embodiments of the disclosure;

FIG. 7A depicts a diagram of an illustrative GPS location enabled connection between different users, in accordance with some embodiments of the disclosure;

FIG. 7B depicts a diagram of an illustrative GPS location enabled connection between different users in reverse to FIG. 7A, in accordance with some embodiments of the disclosure;

FIG. 8 depicts a diagram of an illustrative ability of a device used to translate a picture to text, in accordance with some embodiments of the disclosure;

FIG. 9 depicts a diagram of an illustrative process when boarding a new athlete who becomes a user and is not yet recruited by a third party who is also a user, in accordance with some embodiments of the disclosure;

FIG. 10 depicts a diagram of an illustrative process when a third party is connecting with a user by an interested third party who is also a user, in accordance with some embodiments of the disclosure;

FIG. 11 depicts a diagram of an illustrative process when a third party, specifically a NCAA college, who is a user is connecting with an athlete who is not yet a user, in accordance with some embodiments of the disclosure;

FIG. 12A depicts a diagram of an illustrative process when a third party, specifically an Agent/Counselor subject to representation rules under “Agent Representation” with the NCAA, who is a user is connecting with an athlete who is not yet a user, in accordance with some embodiments of the disclosure;

FIG. 12B depicts a diagram of an illustrative process when a third party, specifically a Team/League not subject to representation rules under “Agent Representation” with the NCAA, who is a user is connecting with an athlete who is not yet a user, in accordance with some embodiments of the disclosure;

FIG. 13A depicts a diagram of an illustrative process of the steps pre-and-post the engine data manipulation to retrieve desired output, in accordance with some embodiments of the disclosure;

FIG. 13B depicts a diagram of an illustrative process of the steps taken by the engine to retrieve desired output related to the NCAA maximum rule requirements of English, Math, Social Science, Additional Core 1 and Additional Core 4 classes, in accordance with some embodiments of the disclosure;

FIG. 13C depicts a diagram of an illustrative process of the steps taken by the engine to retrieve the desired output related to the NCAA maximum rule requirements of Natural/Physical Science classes, in accordance with some embodiments of the disclosure;

FIG. 13D depicts a diagram of an illustrative process of the steps taken by the engine to retrieve the desired output related to the NCAA minimum rule requirement of 10/7 classes, in accordance with some embodiments of the disclosure;

FIG. 13E depicts a diagram of an illustrative process of the steps taken by the engine to retrieve the desired output related to the NCAA rule requirement applied to athletes who are users and have attended a high school that offered a “lab” class.

FIG. 13F depicts a diagram of an illustrative process of the steps taken by the engine to retrieve the desired output related to the NCAA minimum GPA rule requirement, in accordance with some embodiments of the disclosure;

FIG. 13G depicts a diagram of an illustrative process of the steps taken by the engine to retrieve the desired output related to the NCAA minimum Sliding Scale rule requirement, specifically the minimum ACT and/or SAT Superscore(s), as applicable, in accordance with some embodiments of the disclosure;

FIG. 13H depicts a diagram of an illustrative process of the steps taken by the engine to retrieve the desired forecast output related to the NCAA minimum GPA, SAT Superscore and/or ACT Superscore rule requirement, as applicable, in accordance with some embodiments of the disclosure;

FIG. 14 depicts a diagram of an illustrative process of the process steps taken to calculate a SAT test and/or ACT test Superscore for input, in accordance with some embodiments of the disclosure;

FIG. 15 depicts a diagram of an illustrative process of the process steps taken to retrieve a user “Best Fit” of NCAA Colleges as dependent on user desires, user academic/athletic performance and minimum requirements of NCAA Colleges that may be stricter than the NCAA minimum requirements, in accordance with some embodiments of the disclosure;

FIG. 16 depicts a diagram of an illustrative process of the process steps taken to retrieve future user academic performance requirements to meet minimum requirements of user desired NCAA Colleges that may be stricter than the NCAA minimum requirements, in accordance with some embodiments of the disclosure; and

FIG. 17 depicts a diagram of an illustrative process of users representing themselves and connecting with each-other as focused on skills, qualifications, desires, accomplishments and any other information in addition to academic performance, in accordance with some embodiments of the disclosure.

FIG. 18 depicts a block diagram of an illustrative user equipment device in accordance with some embodiments of the disclosure; and

FIG. 19 depicts a block diagram of an illustrative system in accordance with some embodiments of the disclosure;

FIG. 20A depicts a diagram of an illustrative user experience, in accordance with some embodiments of the disclosure;

FIG. 20B depicts a diagram of an illustrative user experience subsequent to FIG. 20A, in accordance with some embodiments of the disclosure;

FIG. 20C depicts a diagram of an illustrative user experience subsequent to FIG. 20B, in accordance with some embodiments of the disclosure;

FIG. 20D depicts is a diagram of an illustrative user experience subsequent to FIG. 20C, in accordance with some embodiments of the disclosure;

FIG. 20E depicts a diagram of an illustrative user experience subsequent to FIG. 20D, in accordance with some embodiments of the disclosure; and

FIG. 20F depicts a diagram of an illustrative user experience subsequent to FIG. 20A-E, in accordance with some embodiments of the disclosure.

### DETAILED DESCRIPTION

Systems and methods for providing a user interface comprising information about student-athlete eligibility and recommendations to gain eligibility are described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

In the following description and claims, the term “athlete” may refer to any person seeking eligibility to participate in athletics. Generally, athlete refers to a student athlete seeking NCAA eligibility, e.g., by using Eligibility Wizard. An athlete may be an actual student-athlete or a student's parent or legal guardian but is not limited thereby. An athlete may interact with Eligibility Wizard via a GUI. The term “eligibility” and/or “eligibility state” may refer to an ability of an athlete to compete at an institution in any capacity, e.g., by meeting minimum requirements set by a governing body. The term “NCAA” may refer to the National Collegiate athlete Association, its subsidiaries and/or affiliates. The NCAA may be considered an exemplary governing body for student-athletes and other governing bodies or institutions may be substituted. Minimum requirements of eligibility may be changed by a governing body, e.g., the NCAA, at times and any exemplary eligibility requirements described herein should be understood as examples that may be adjusted or changed.

The term “GUI” may refer to graphical user interface, alternatively GUI may refer to an interactive page on a device webpage or application. The term “engine” may refer to systems, methods, apparatuses, and related algorithms for manipulating input data to produce desired output data. The term “Retail” may refer to one or more parts of some embodiments used by athletes to interact with third parties or Eligibility Wizard exclusively. The term “third party” means any person interacting with and/or procuring information from an athlete by using Eligibility Wizard such as an institution, admissions representative, coach, scout, recruiter, manager, agent, athletic department representative, or other interested party. A third party is also able to interact with Eligibility Wizard independently. A third party interacts with Eligibility Wizard via a “Wholesale” GUI. The term “Wholesale” may refer to one or more parts of some embodiments used by third parties that interacts with athletes or the features of Eligibility Wizard exclusively to third parties. The term “user” may refer to any person using Eligibility Wizard whether an athlete or third party.

The term “Class” may refer to an individual classes within each Category that the NCAA has identified as acceptable to complete by an athlete that will count towards eligibility. The term “Category” may refer to class subjects of, e.g., English, Math, Natural/Physical Science, Social Science and Additional Core classes identified as acceptable classes to complete by and athlete that will count towards eligibility. The term “Warning” may refer to quantitative, subjective, or other limitations of a Class that may need more information and/or further action by an athlete to fully understand how to proceed if such class is potentially either chosen or omitted by an athlete.

The term “Core Courses” may refer to only classes at a respective high school that can be used by an athlete for purposes of eligibility. The term “Credit” may refer to the multiplier assigned to a Class grade given to an athlete by a high school teacher after completing a Class. A Credit cannot exceed a value of one but can be partial as determined by the NCAA. A Credit should not be confused with a value that is on a transcript an athlete uses to input information into Eligibility Wizard.

The term “grade” may refer to the numeric, metric, or Pass/Fail performance assignment to a class as awarded to an athlete on his/her transcript by a high school. The term “GPA” may refer to a number by using all Core Classes and dividing them by the total Credits of those Core Classes to achieve an overall Grade Point Average. For clarification herein, unless otherwise noted, the term GPA shall refer to the number when only including Core Classes as determined by the NCAA. The term “transcript” may refer to the document an athlete will receive by its high school after completing each class grade (e.g., Freshman, Sophomore, Junior, Senior) which an athlete will use as a source of input to Eligibility Wizard.

The term “Test Score” may refer to any required scores to be submitted to the NCAA. For instance, the NCAA or governing body may require one or more standardized test scores. Currently, but not limited to, the term Test Score references ACT and/or SAT Test Scores. The term “Superstore” may refer to finding the highest value across multiple SAT test and/or ACT test component scores to derive a cumulative highest overall respective Test Score for input.

The term “Full Qualifier” may refer to an athlete being able to compete without any restrictions at a NCAA college. The designation may be awarded by the NCAA as a conclusion to the eligibility process should an athlete satisfy all requirements. The term “Partial Qualifier” may refer to an athlete being able to attend a NCAA college but not yet able to compete without satisfying additional requirements during the first year of enrollment (sometimes referred to a “Redshirt”). For instance, a “Partial Qualifier” designation is awarded by the NCAA as a conclusion to the eligibility process should an athlete satisfy all requirements but has a final GPA between 2.0 and 2.3.

The NCAA eligibility Center (formerly called the NCAA Clearinghouse) evaluates athletes under a set of rules related to athletic status and academic performance. The athletic status is reviewed when an athlete applies for final certification with the NCAA no sooner than a few months prior to graduating from high school. The review is a questionnaire that must be answered at a point where if provided answers contradict an athlete's “amateur” status as determined by the NCAA, the athlete will be deemed not eligible. A finding of not eligible could potentially mean permanent disqualification from competing at an NCAA college.

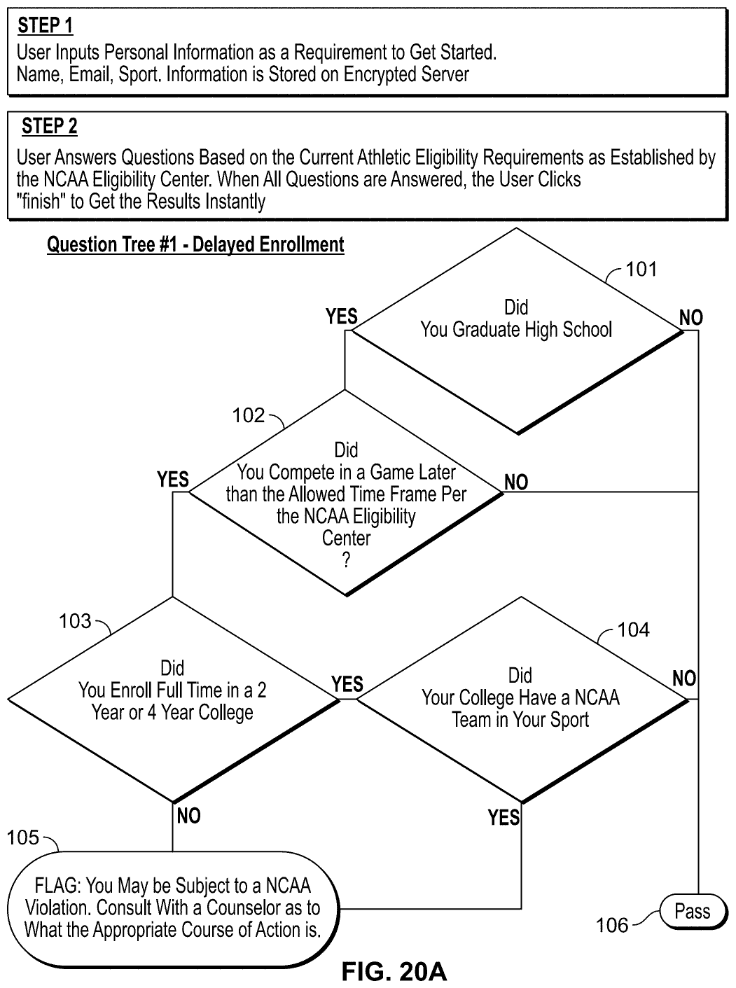

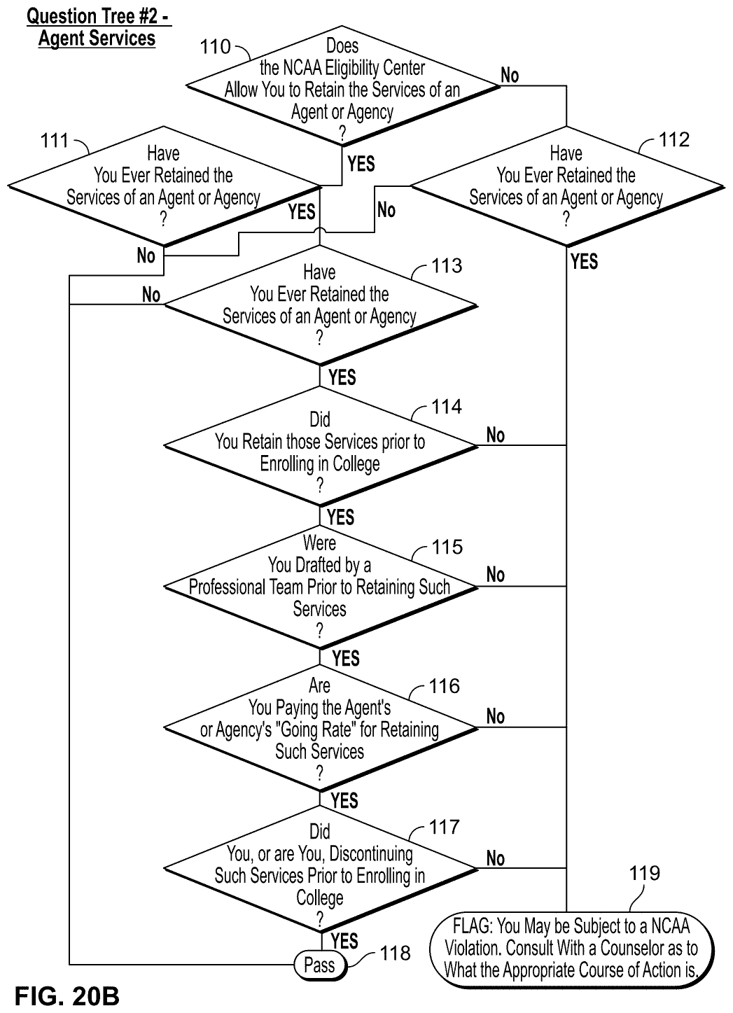

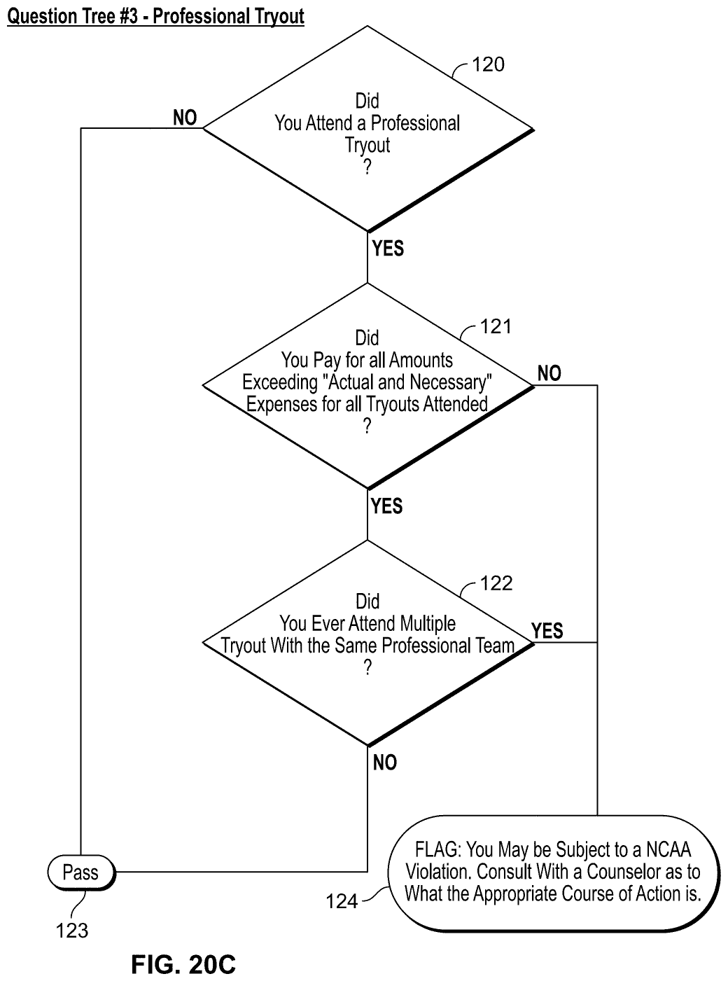

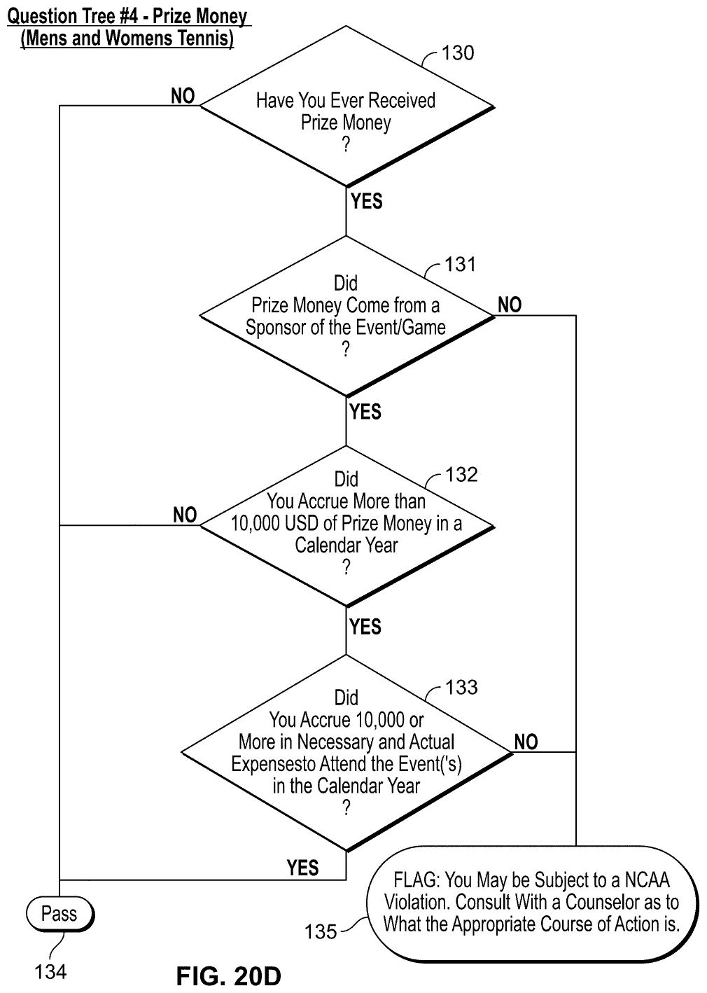

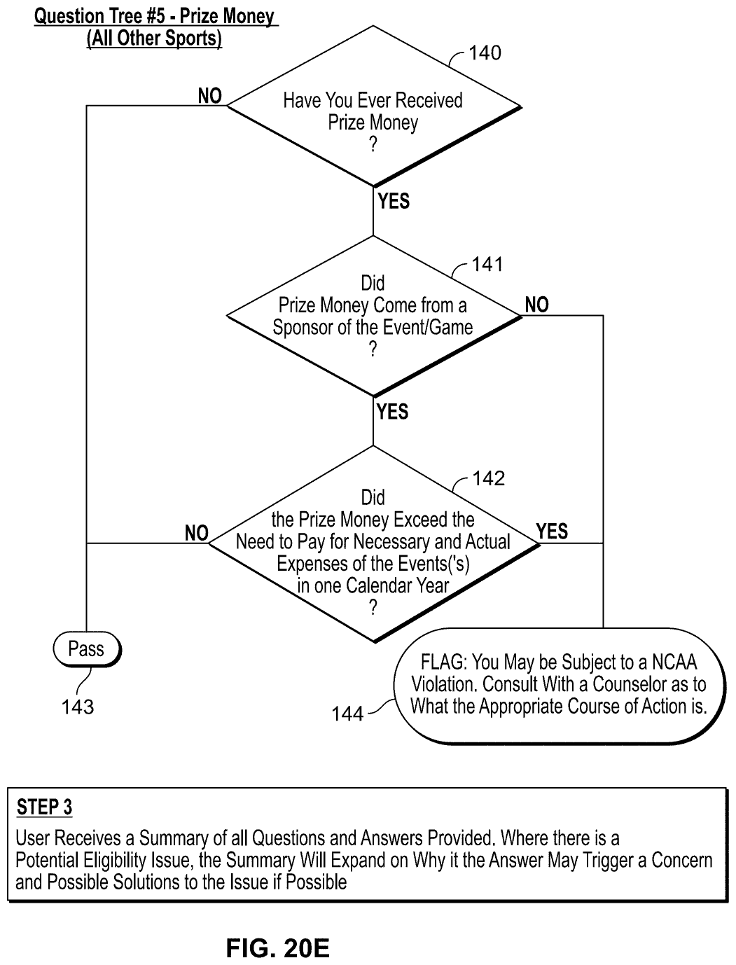

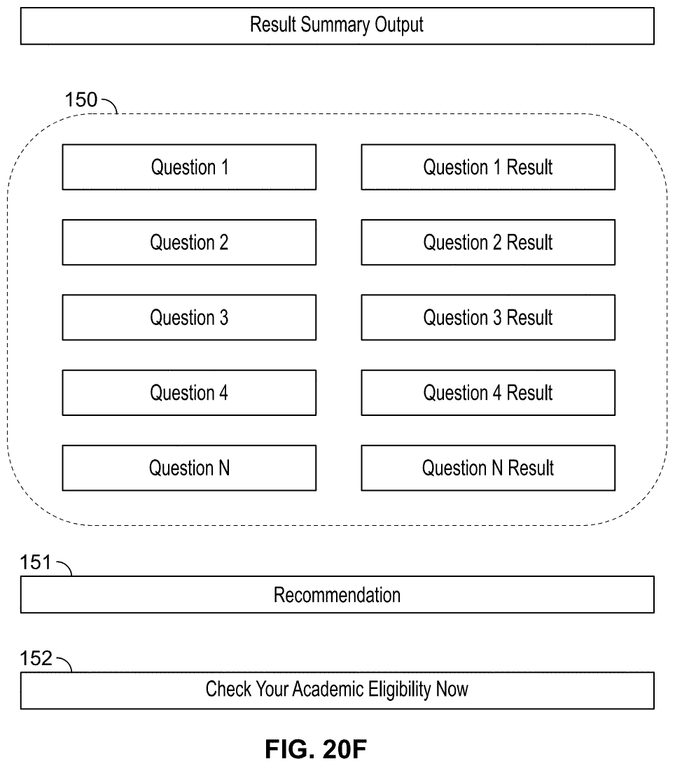

The eligibility process for collegiate athletics by the NCAA is currently only reactive in arrears. Limited proactive information is disseminated by various actors, including the NCAA, in various public places, e.g., the internet. Some approaches may provide a proactive checklist an athlete can complete to ensure their status is currently in good standing or, if not, potential action can be taken to remedy any shortcomings before taking the actual test with the NCAA. Some approaches may ask an athlete one or several questions per requirement as dependent on their answers. In some embodiments, a checklist-type feature may notify a user when he/she may achieve a “Pass” or a “Flag” will continue to be presented for the next question until a result set, e.g., FIG. 20F.

The academic status is a set of rules the NCAA has established to make sure athletes in high schools are preparing themselves for success at a NCAA college apart from their athletic ability. These rules ensure an athlete has completed their high school education at approved schools and taken a sufficient amount of NCAA Core Classes, received high enough grade in each of these classes and that they have been taken at an acceptable pace. These requirements are generally disseminated and made available to the public by the NCAA, however, athletes make many irrevocable mistakes due to subjective or quantitative requirements only relating to one or several high schools attended. In addition, some athletes decide to put themselves in a predicament due to examples such as school transfers, repeating classes or repeating entire grades (e.g., Freshman, Sophomore, Junior, Senior) which creates many confusing, and sometimes unwritten, problems that could result in a permanent disqualification from participating as an athlete at a NCAA college. The NCAA has eleven rules that must be met within four years of an athlete starting high school.

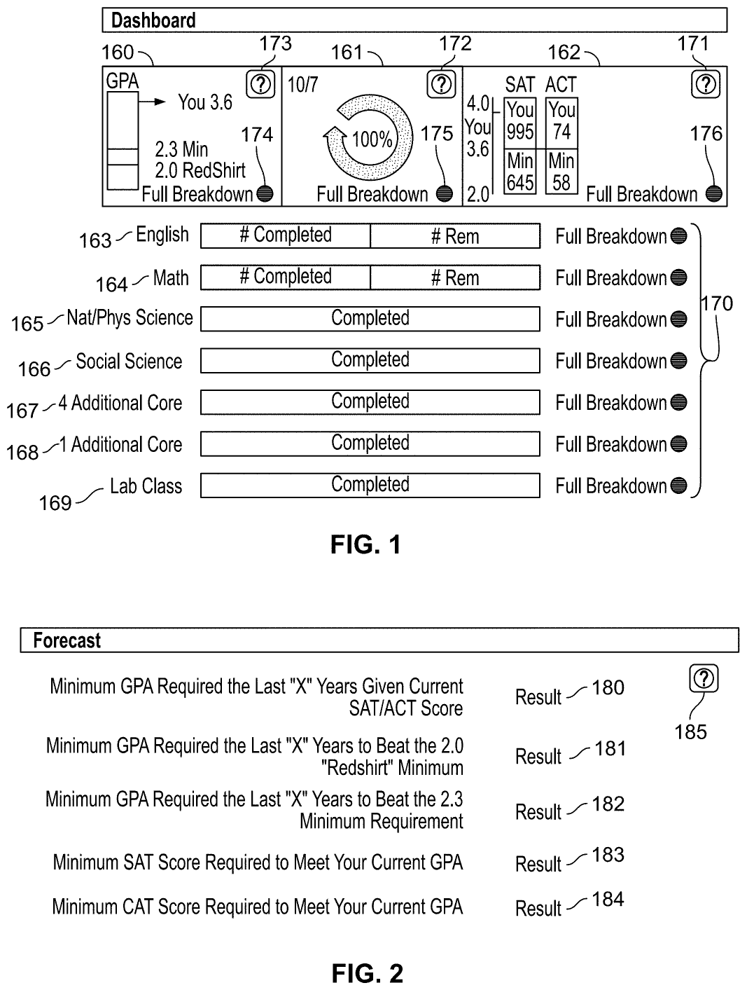

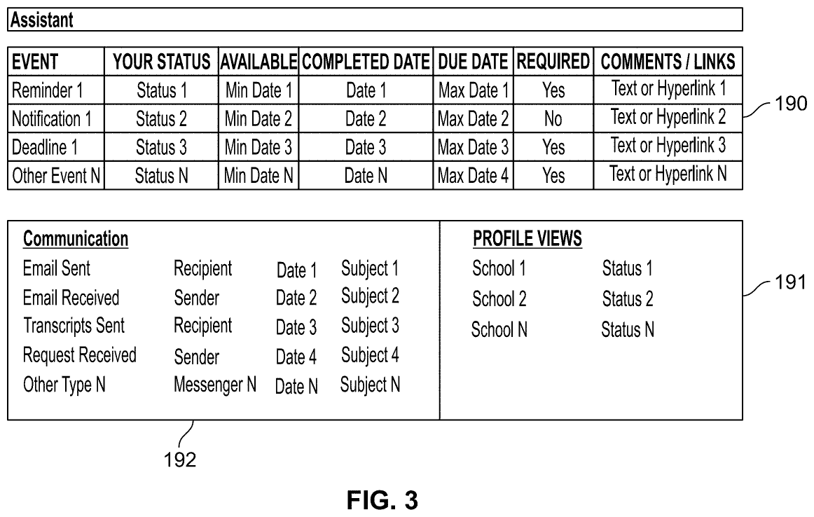

Some embodiments may provide a status per each rule in a Dashboard. FIG. 1 depicts an example of a Dashboard that a user can interact with in reference to all NCAA academic requirements.

Some embodiments may incorporate a GPA rule. For instance, the NCAA's GPA rule is a minimum requirement that each athlete must exceed a GPA using NCAA Core Classes only that meet-or-exceed a total of 16 total Credits with a satisfying grade and within a limited amount of time, of 2.3 in order to be a Full Qualifier or a 2.0 to be Partial Qualifier. The output 160 is a visual interaction of an athlete's current performance against this rule. An explanation of the rule is available 173 and an athlete's classes used to determine the status is available 174.

Some embodiments may incorporate a 10/7 rule. For instance, the NCAA's 10/7 rule is a minimum requirement that each athlete must complete ten full NCAA Core Class Credits or more, of which seven must be in the categories of English, Math and Natural/Physical Science and with a satisfying grade, by the completion of the third high school year. The output for 10/7 class progress 161 is a visual interaction of an athlete's current academic performance against this rule. An explanation 172 of the rule is available and an athlete's classes used to determine the status is available 175.

Some embodiments may incorporate a Sliding Scale rule. For instance, the NCAA's Sliding Scale rule is a minimum requirement that each athlete must exceed a minimum SAT Superscore or ACT Superscore, based on their GPA using NCAA Core Classes to meet-or-exceed 16 total Credits with a satisfying grade. The higher the GPA, the lower the SAT Superscore or ACT Superscore per a publicly available Sliding Scale publicly published by the NCAA. Output 162 is a visual interaction of an athlete's current performance against this rule. An explanation of the rule is available 171 and an athlete's classes used to determine the status is available 175.

Some embodiments may incorporate a rule for English classes. For instance, the NCAA's English rule is a minimum requirement that each athlete must meet-or-exceed 4 total Core Class Credits in the Category of English with a satisfying grade. Output 163 is a visual interaction of an athlete's current performance against this rule. An athlete's classes used to determine the status is available 170 accompanied with an explanation of the rule.

Some embodiments may incorporate a rule for Math classes. For instance, the NCAA's Math rule is a minimum requirement that each athlete must meet-or-exceed 3 total Core Class Credits in the Category of Math with a satisfying grade. Output 164 is a visual interaction of an athlete's current performance against this rule. An athlete's classes used to determine the status is available 170 accompanied with an explanation of the rule.

Some embodiments may incorporate a rule for Science classes. For instance, the NCAA's Natural/Physical Science rule is a minimum requirement that each athlete must meet-or-exceed 2 total Core Class Credits in the Category of Natural/Physical Science with a satisfying grade. Output 165 is a visual interaction of an athlete's current performance against this rule. An athlete's classes used to determine the status is available 170 accompanied with an explanation of the rule.

Some embodiments may incorporate a rule for English classes. For instance, the NCAA's Social Science rule is a minimum requirement that each athlete must meet-or-exceed 2 total Core Class Credits in the Category of Social Science with a satisfying grade. Output 166 is a visual interaction of an athlete's current performance against this rule. An athlete's classes used to determine the status is available 170 accompanied with an explanation of the rule.

Some embodiments may incorporate a rule for additional core classes. For instance, the NCAA's 4 Additional Core rule is a minimum requirement by the NCAA that each athlete must meet-or-exceed 4 total and additional Core Class Credits, beyond each requirement per categories explained in 163, 164, 165 and 166, in the Category of English, Math, Natural/Physical Science, Social Science or Additional Core categories. Output 167 is a visual interaction of an athlete's current performance against this rule. An athlete's classes used to determine the status is available 170 accompanied with an explanation of the rule.

Some embodiments may incorporate a rule for other core classes. For instance, the NCAA's 1 Additional Core rule is a minimum requirement by the NCAA that each athlete must meet-or-exceed 1 total and additional Core Class Credit, beyond each requirement per categories explained in 163, 164, 165 and 166, only using NCAA approved classes in the Category of English, Math or Natural/Physical. Output 168 is a visual interaction of an athlete's current performance against this rule. An athlete's classes used to determine the status is available 170 accompanied with an explanation of the rule.

Some embodiments may incorporate a rule for laboratory classes. For instance, the NCAA's The Lab Class rule is a minimum requirement by the NCAA that each athlete must meet-or-exceed 1 total Core Class Credit by completing a Lab Class with a satisfying grade, but only if the current, or any previous, high school attended by an athlete actually offered a Lab Class. Output 169 is a visual interaction of an athlete's current performance against this rule. An athlete's classes used to determine the status is available 170 accompanied with an explanation of the rule.

Some embodiments may incorporate descriptions for rules, metrics, and goals. One of the most important variables in achieving an academic performance goal of an athlete is to have a metric understanding of what that goal is. Athletes who do not have certain performance components provided to them may be left without proper guidance on how to overcome potential eligibility risks in the future, for instance, if they are unaware of an actual metric requirement to achieve such a goal. For example, when an athlete finds out their GPA is not satisfying the minimum rule of 2.3 but an athlete still has the option to select classes in the future, some embodiments may provide an athlete with the necessary GPA required using only the remaining classes. A GPA forecast may be provided to an athlete 182 with a description available 185.

In some embodiments, a Minimum GPA forecast to meet the 2.0 minimum GPA requirement may be provided to an athlete 181 with a description available 185. Likewise, a minimum GPA Forecast to meet the SAT Superscore or ACT Superscore, if either standardized test is taken, per the Sliding Scale requirement as established by the NCAA is available to an athlete 180 with a description available 185. Some embodiments may use the lesser of the SAT Superscore and ACT Superscore requirement to establish the minimum GPA forecast.

In some embodiments, a Minimum SAT Superscore forecast to meet-or-exceed the minimum SAT Superscore requirement per the current GPA using only previously taken NCAA approved classes of an athlete is provided to an athlete 183 with a description available 185.

In some embodiments, a Minimum ACT Superscore forecast to meet-or-exceed the minimum ACT Superscore requirement per the current GPA using only previously taken NCAA approved classes of an athlete against the Sliding Scale is provided to an athlete 184 with a description available 185.

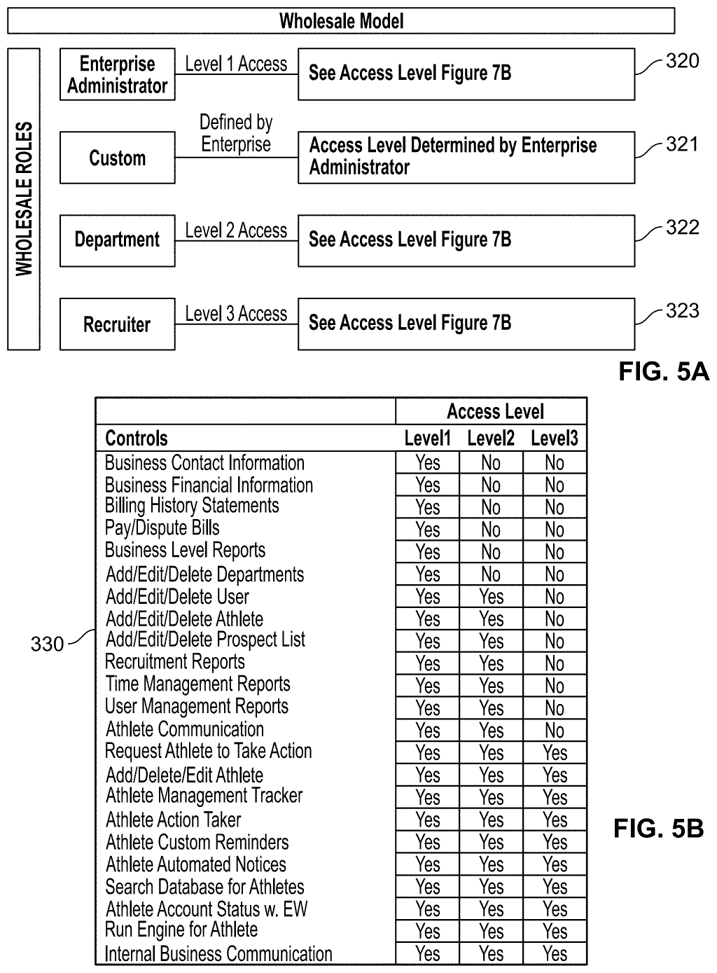

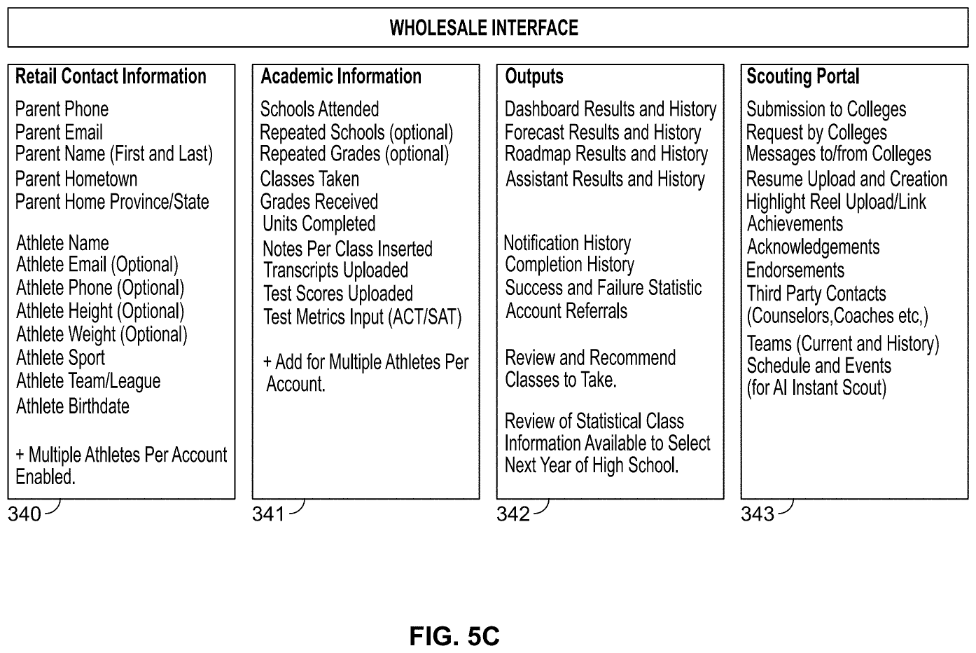

Some embodiments may allow an athlete to communicate with third parties. For instance, these communications may help an athlete stay organized and take proactive action towards various deadlines to make optimal progress towards eligibility. FIGS. 5A-B depict examples of what some embodiments may provide an athlete and/or third party to meet these objectives. Table 190 is a description of events that need an action, the status of such action, whether such action is yet available as it will populate at a time at-or-before it becomes necessary, the date the action was completed, the due date when applicable, an indication whether the action is required and any comments related to the event. Table 191 tracks any views of a specific user profile to encourage they establish a connection subject to potential recruiting restrictions imposed by regulatory bodies, including but not limited to the NCAA.

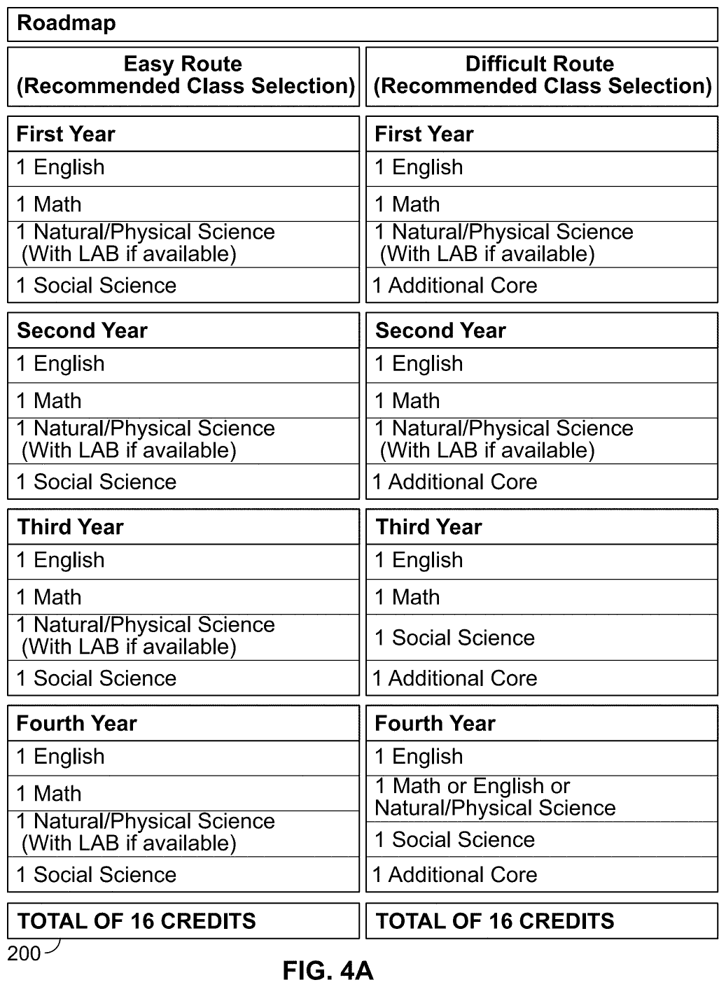

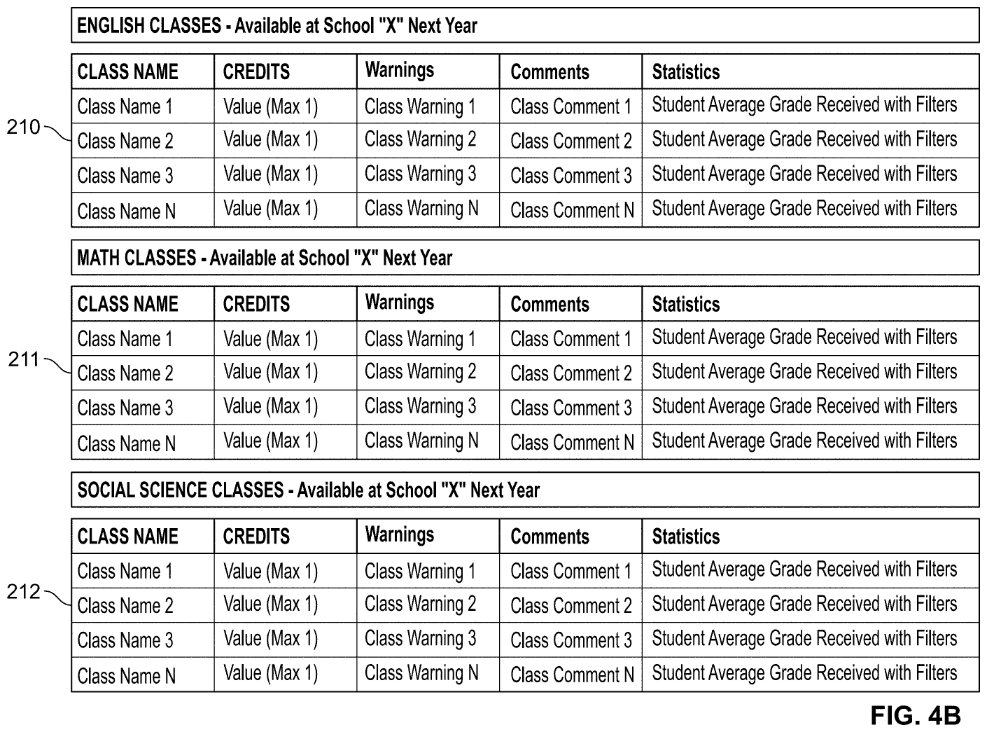

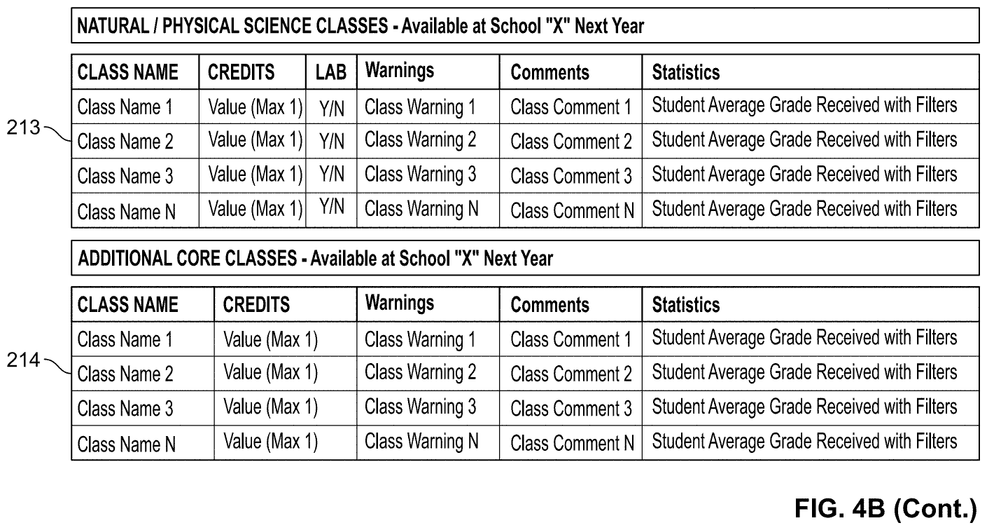

A part of some embodiments is the ability of an athlete to proactively make choices that are specific to their path towards eligibility. This is an essential part to an athlete that is proactive and non-existing in the current marketplace as some embodiments is customized to each athlete's path towards eligibility. Some embodiments may explain common Core Class selection criteria towards eligibility in terms of what Core Classes, in what categories and at what time they should be taken to accomplish all goals with exception of the Sliding Scale 162 requirements. Description 200 in FIG. 4A is a necessary precursor to FIG. 4B that will provide complete transparency as to what Class selections to make in the respective subject categories and why. The Category of English is currently requiring an athlete to complete 4 credits or more 163 and an athlete can select the NCAA approved classes at their specific school from a list 210 by name, the amount of Credits assigned to the Core Class, any Warnings assigned to the Core Class, any additional comments from other athlete's about the class and Statistics an athlete can access that describe the success rate of previous athlete's taking that Core Class including, but not limited to the percent of certain grades received by other athletes on average. Similarly, some embodiments may enable an athlete to review the same information in Math 211, Social Science 212, Additional Core Classes 214. Natural/Physical Science 213 adds the ability to review whether a Core Class is a Lab Class. This is a separate requirement each athlete may be subject to Lab Class requirement 169.

Third party recruiters, whether a NCAA college, a team, a league or a consultant, want to focus on the athletic ability of an athlete more than the academic ability. At times, the expertise and organization skills of a third party is very limited and sometimes counteractive to an athlete's path towards eligibility. A unique and very valuable part of some embodiments to third parties is the replacement of expertise requirements that, if presented erroneously, could become problematic to an athlete, including potentially causing an athlete becoming ineligible. Furthermore, the third party can eliminate a lot of the time spent on eligibility management of an athlete and allow some embodiments to take care of a majority of that process. Also, and potentially the most valuable part of some embodiments, is the ability of a third party to proactively assess a very high likelihood an athlete will ultimately become eligible at a much earlier stage in the recruitment process than what is currently available. Should there be a problem with an athlete's decisions currently or historically made, some embodiments may provide customized solutions immediately that can be taken at the option of each athlete.

Some embodiments may use a Wholesale model as an interactive GUI for third parties. FIG. 5A depicts the third-party user controls that can be assigned. Most third parties are large entities that manage athletes in different sports with multiple recruiters and/or multiple departments. Some embodiments may allow third parties to set access controls to different levels of users described in 320, 321, 322 and 323. Enterprise Administrator 320 is the main contact of the third party interacting with the staff and has complete access including, but not limited to what is described in Access Level 1 330. An example of an Enterprise Administrator could be the Athletic Director at a NCAA college, an owner of a team, league, or talent agency.

Some embodiments may include a custom access level. A Custom access level 321 is an Enterprise Administrator but allows the staff to uniquely assign Access Levels to this person to smaller third parties who may not need all Access Controls available within some embodiments. The staff can select Access Levels described in Table 330 of FIG. 5B that will best suit this third party's needs. Department 322 is a subsidiary access level to the Enterprise Administrator 320 or Custom 321 that has access that includes, but is not limited to, what is described in Access Level 2 (330 of FIG. 5B). An example of a Department may be a head coach of a soccer team at a NCAA College or, potentially, a football agent within a talent agency, etc.

Recruiter 323 is a subsidiary access level to both the Enterprise Administrator 320, Custom 321 and the Department 322 that has access that includes, but is not limited to what is described in Access Level 3 (330 of FIG. 5B).

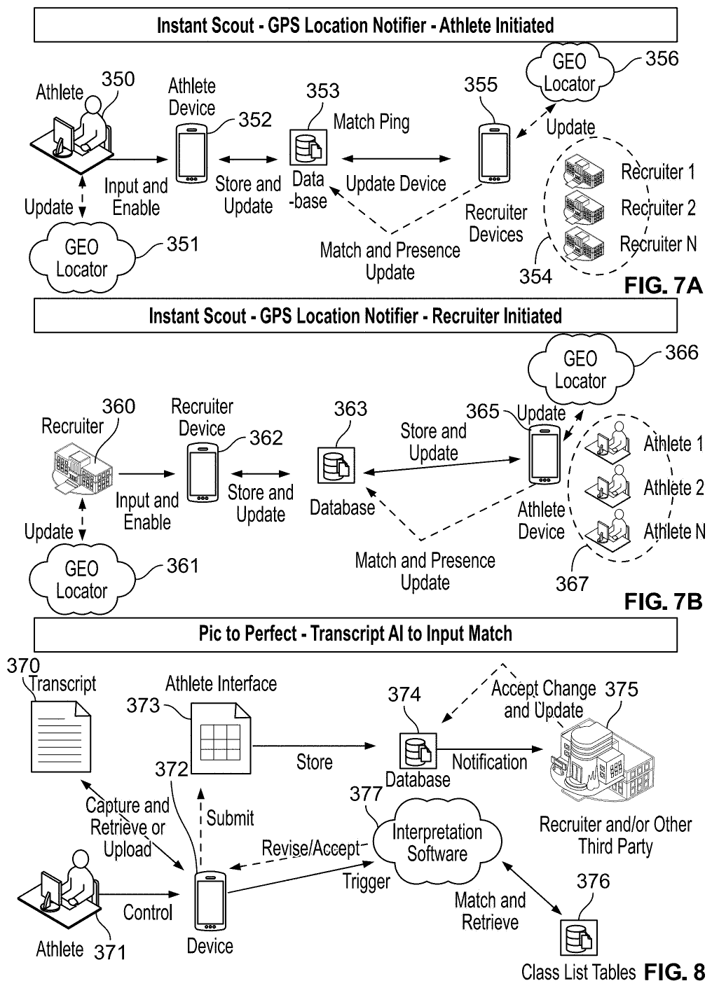

Table 330 of FIG. 5B depicts an exemplary list of control features that may be allowed to be edited by each access level control described in FIG. 7A. These features may change and/or additional features may be added or omitted in some embodiments.

FIG. 5C depicts an example of information the Wholesale GUI may make and provide to third parties in some embodiments. Example of information related to an athlete is listed in athletic information lists 340, 341, 342 and 343. Contact, demographic and certain athletic information 340 may be separated from an athlete's academic information 341. Outputs generated in some embodiments based on an athlete's inputs may have their own section, e.g., information 342. In some embodiments, communication with (or by) an athlete and résumé-related items of an athlete to strengthen an athlete's recruitment profile to third parties will have its own section 343.

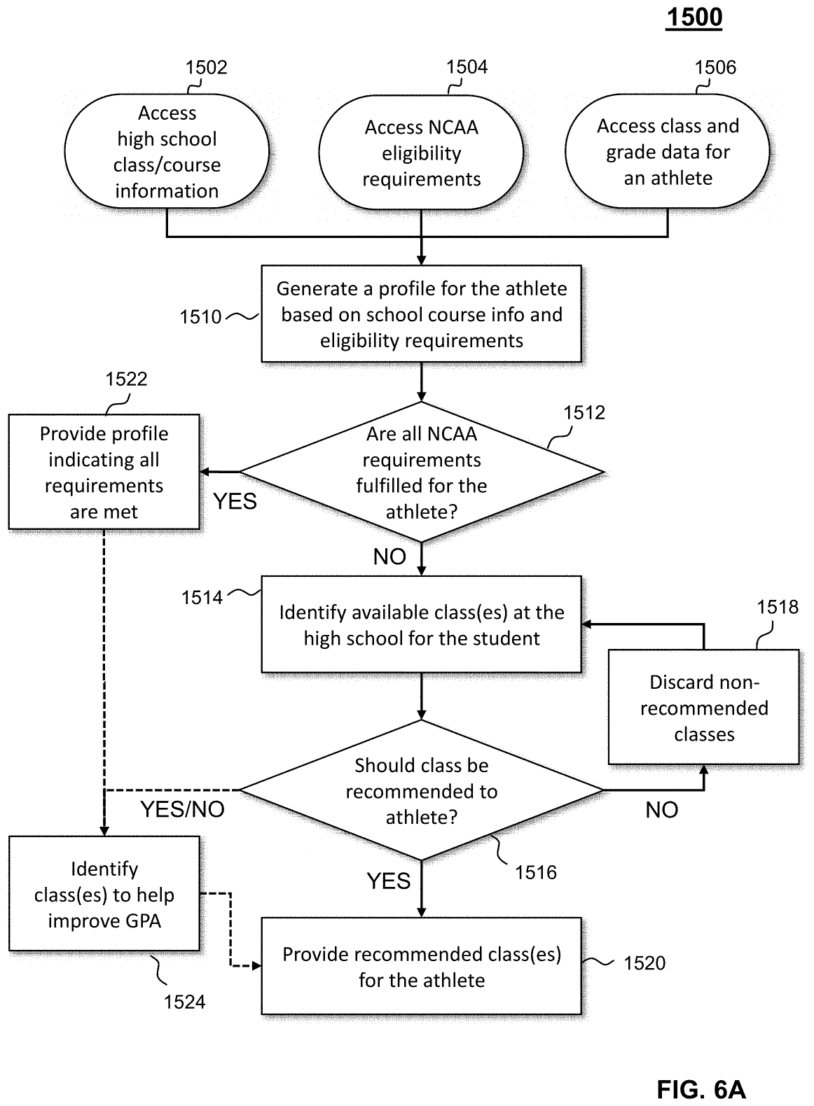

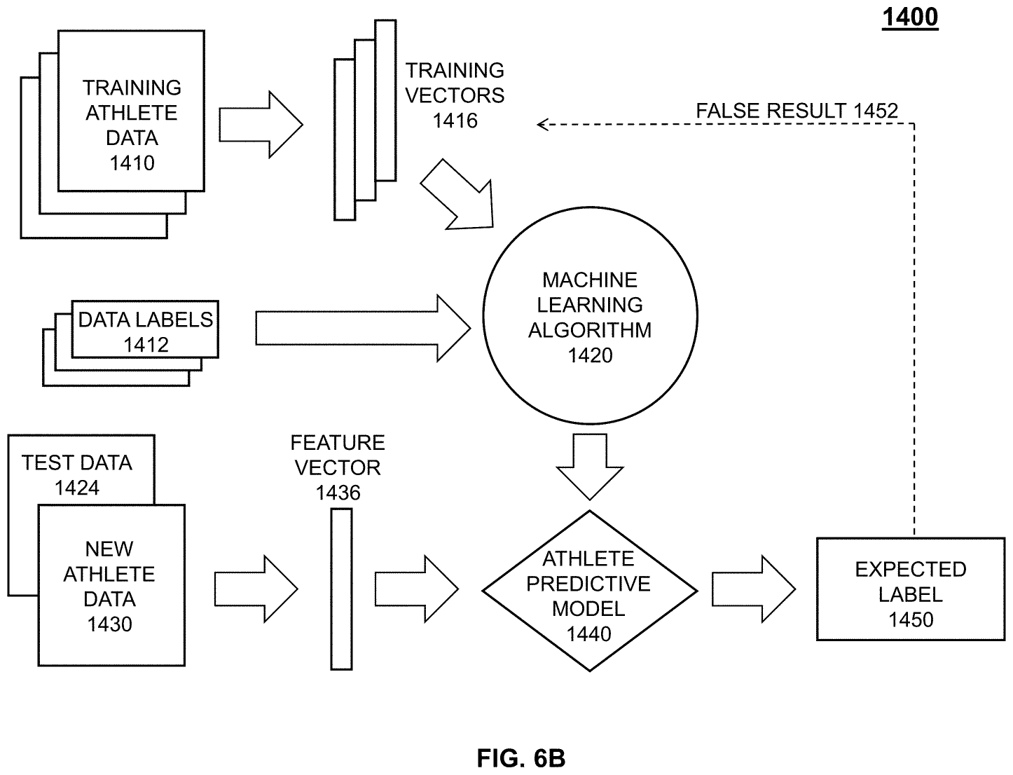

FIG. 6A depicts an illustrative flow chart of a process FIG. 6A depicts an illustrative flow chart of a process for providing a recommendation for an athlete to achieve eligibility, in accordance with some embodiments of the disclosure. There are many ways to identify recommendations for a particular athlete at a particular school and ahead of a particular year/semester, generate, organize, and present bookmarks, and process 1500 of FIG. 6A is an exemplary method of generating an athlete profile and providing a recommendation.

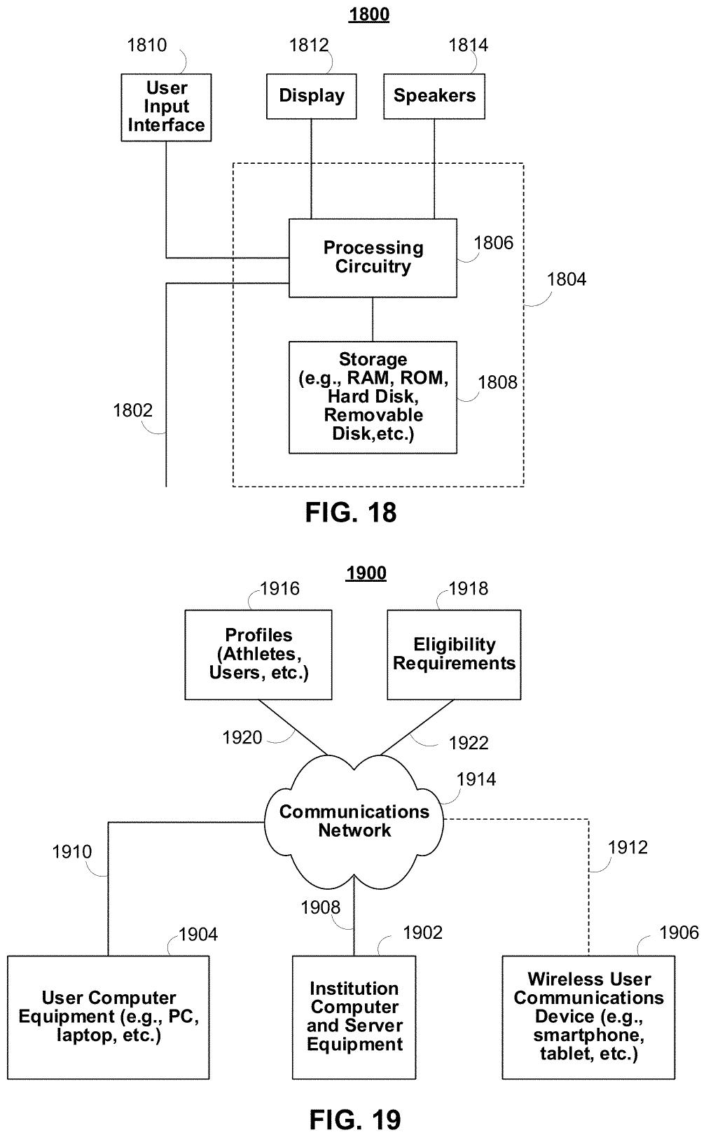

Some embodiments may utilize an eligibility engine (sometimes referred to as just “engine” in this disclosure) to perform one or more parts of process 1500, for instance, as part of an application (e.g., an Eligibility Wizard application), stored and executed by one or more of the processors and memory of a device and/or server such as those depicted in FIGS. 18 and 19. For instance, an eligibility engine may run on a web server. An eligibility engine may run on one or more components of a computer, smartphone, tablet, or other device able to access a content delivery network.

At step 1502, the eligibility engine accesses high school class/course information. storing, in the storage equipment, course information from one or more high schools. In some embodiments, the eligibility engine may access class/course information from the NCAA and/or based on information submitted by schools to the NCAA. In some embodiments, the eligibility engine may access class/course information directly from a high school (e.g., via administration communication). In some embodiments, the eligibility engine may access class/course information based on other athletes' transcript data.

At step 1504, the eligibility engine accesses NCAA eligibility requirements. In some embodiments, the eligibility engine may store, e.g., in storage equipment, eligibility requirements for student athlete candidates from a governing body (e.g., the NCAA) that at least partially defines an eligibility state, e.g., for participating in athletics based on academic qualifications. In some embodiments, the eligibility requirements may further comprise a plurality of standardized test scores each with a corresponding grade point average (e.g., a sliding scale). Some embodiments may incorporate academic requirements from one or more educational institutions, as well. For instance, a particular conference, such as the Ivy League or the Patriot League, or a particular college, such as Harvard or Stanford, may have more stringent academic requirements for incoming student-athletes. Such requirements may be a minimum amount of science or language classes, a minimum GPA and/or minimum test scores.

At step 1506, the eligibility engine accesses class and grade data for an athlete. In some embodiments, the eligibility engine may receive, via a communications network, academic information for a student athlete candidate. In some embodiments, the academic information comprises a candidate standardized test score.

At step 1510, the eligibility engine generates a profile for the athlete based on school course info and eligibility requirements. Some embodiments may generate, e.g., using processing circuitry, a profile for the student athlete candidate using course information and academic information. In some embodiments, the profile for the student athlete candidate may further comprise some eligibility requirements (e.g., from the NCAA or another institution).

At step 1512, the eligibility engine determines if all the NCAA requirements are fulfilled for the athlete. In some embodiments, the eligibility engine may determine, using the processing circuitry, a difference in a current state of the student athlete candidate and the eligibility state based on the profile.

At step 1514, the eligibility engine identifies available class(es) at the high school for the student. In some embodiments, the eligibility engine may start with a complete list of classes available at the high school, eliminate classes that have been taken and classes allowed for grade-levels lower than the athlete's current grade level. In some embodiments, the eligibility engine may eliminate classes the athlete does not qualify for, e.g., a mathematics class with unfulfilled prerequisites or a high-level foreign language class of a different language. In some embodiments, the eligibility engine may use a full list and depend on filters and processing at the next stage to weed out classes that should not be recommended (e.g., via machine learning or data analytics).

At step 1516, the eligibility engine determines if a class should be recommended to the athlete. In some embodiments, the eligibility engine may determine, e.g., using processing circuitry, at least one recommendation for allowing the student athlete candidate to achieve the eligibility state. Some embodiments may determine the recommendation(s) using a trained machine learning model to generate data indicative of courses for the student athlete candidate to achieve the eligibility state. FIG. 6B depicts a flow diagram for training a model to recommend classes/courses. In some embodiments, a trained machine learning model is trained to receive information about courses, grades for those courses (and credits), and at least some other information from the profile as input, and output one or more courses that would help achieve a desired grade point average.

Some embodiments may determine recommendations using a data analytics technique to generate data indicative of courses for the student athlete candidate to achieve the eligibility state. In some embodiments, the data analytics techniques may comprise processing profiles of a plurality of other students to identify similar profiles of the student athlete candidate and to determine which courses taken by students associated with the similar profiles resulted in grades that would help that would achieve the eligibility state.

In some embodiments, determining the at least one recommendation may further comprise comparing a candidate standardized test score to the plurality of standardized test scores. If a sufficient SAT or ACT score is earned, a lower minimum GPA may be acceptable, and certain classes (e.g., math, science, lab classes) may be recommended. For instance, the eligibility requirements may further comprise a plurality of standardized test scores each with a corresponding grade point average (e.g., sliding scale), academic information comprises a candidate standardized test score, and the eligibility engine may determine at least one recommendation by, e.g., comparing the candidate standardized test score to the plurality of standardized test scores.

At step 1518, the eligibility engine may discard non-recommended classes. For instance, classes/courses that are not identified as recommended at this point may be removed from the list of available classes. Classes may be filtered out by perquisites and/or year/grade-level requirements. In some embodiments, non-recommended classes may be presented as a separate list. In some embodiments, certain classes may be neutral or not recommended, while other classes may be recommended to avoid. In some embodiments, newly introduced classes may be categorized as such and presented rather than dismissed as not recommended due to insufficient data.

At step 1520, the eligibility engine provides recommended class(es) for the athlete. providing, over the communications network, the at least one recommendation. In some embodiments, the eligibility engine may generate a GUI with a dashboard featuring charts, graphs, and other pictorial representations of progress. For instance, some embodiments may generate for display a graphical user interface comprising the at least one recommendation in a first section and a portion of the profile in a second section. In some embodiments, the recommendations may be presented along with profile progress in comparison to requirements for a specific school or conference. For example, the eligibility engine may determine whether the student athlete candidate meets the requirements from at least one of the one or more educational institutions based on the profile. In some embodiments, in response to determining the student athlete candidate meets the requirements (e.g., of the governing body or a specific institution), the engine may provide some profile data to one or more educational institutions via a parent portal or a coach's portal or an admissions portal (e.g., the Wholesale platform).

At step 1522, if the eligibility engine determines if all the NCAA requirements are fulfilled for the athlete at step 1512, the eligibility engine provides the athlete's profile indicating all requirements are met. In some embodiments, the eligibility engine may generate a GUI with a dashboard featuring charts, graphs, and other pictorial representations of progress. In some embodiments, the eligibility engine may generate data to export or transfer to the NCAA, a school, a coach/recruiter, etc.

At step 1524, if the requirements are met and there is still time left before graduating high school, the eligibility engine may identify some recommended classes to help improve GPA. In some embodiments, a trained machine learning model generates data indicative of courses for the student athlete candidate to achieve a minimum grade point average. For instance, a model may review other athletes' profile for qualifying classes with corresponding grades that helped their GPAs.

FIG. 6B depicts an illustrative flow diagram of a process, process 1400, for training a machine learning model to detect bookmark topics in content data, in accordance with some embodiments of the disclosure. In some embodiments, providing a recommendation to an athlete may be accomplished with predictive modeling. For instance, a trained neural network may be used to identify classes that have helped a similarly positioned athlete previously. Generally, a training set comprising athlete profiles with a list of classes, grades, categories (e.g., class of subject, like English, Math, etc.) and other profile data, along with labels may be used to train a neural network to predict a class as a recommended course (or as a non-recommended course) when new athlete data is input. Generally, recommended classes will be classes that have helped past athletes fulfill requirements and/or boost GPA and, thus, may be of help now.

Training a neural network to accurately detect recommended classes for a particular athlete profile may be accomplished in many ways. Some embodiments may use supervised learning where, e.g., a training data set includes labels identifying classes as, e.g., “recommended,” “not recommended,” or neutral. Some embodiments may use unsupervised learning that may identify bookmark topics in training data by clustering similar data. Some embodiments may use semi-supervised learning where a portion of labeled content data may be combined with unlabeled data during training. In some embodiments, reinforcement learning may be used. With reinforcement learning, a predictive model is trained from a series of actions by maximizing a “reward function,” via rewarding correct labeling and penalizing improper labeling. Scenario 1400 includes data labels 1412, indicating a supervised or semi-supervised learning situation.

Scenario 1400 depicts training athlete data 1410 along with data labels 1412. Training data for recommended class identification may be collected by manually labeling classes for prior athlete profiles based on the class, category, grade, semester taken, date, school, and other information. For instance, each class, category, grade, semester, etc. may form a class vector in some embodiments. In some embodiments, a class vector for an athlete may also comprise a portion of the athlete's profile so that each class may be evaluated in view of, e.g., the athlete's eligibility status, GPA, test scores, completed category requirements, etc. at the time the class was taken. In such cases, each class may be evaluated for recommendation based on the athlete's goals to fulfill NCAA requirements at the time.

In scenario 1400, class vectors may make up training vectors 1416. Training athlete data 1410 is pre-processed using feature extraction to form training vectors 1416. In some embodiments, each class vector may be labeled “recommended,” “not recommended,” or “neutral.” In some embodiments, each vector (e.g., class and corresponding data) may be given a recommendation score, e.g., on a scale of 0.00 to 1.00, a scale of 1 to 10, and/or values of 1, 2, or 3 (e.g., with the higher numbers indicating classes with higher recommendations). In some circumstances, an analyst may mark each class from prior athlete profile data with one or more recommendation label to create the training data set. From the content data collected, at least two groups of data may be created: training athlete data 1410 and test data 1424.

Pre-processing of training data may be used to obtain proper data for training. In some embodiments, pre-processing may involve, for example, scaling, translating, rotating, converting, normalizing, changing of bases, and/or translating coordinate systems in content data. In some embodiments, pre-processing may involve filtering content data, e.g., to eliminate content noise. In some embodiments, text may be extracted and interpreted. In some embodiments, text may be converted to numbers and vice versa.

After pre-processing, training vectors 1416 are fed into Machine Learning Algorithm (MLA) 1420 to generate an initial machine learning model, e.g., athlete predictive model 1440. In some embodiments, MLA 1420 uses numbers, e.g., between 0.00 and 1.00 for topics and then translates the numbers to a word, e.g., “recommended,” based on being above a predetermined threshold (e.g., 0.66). The more athlete data that is provided, the more accurate MLA 1420 will be in creating a model, e.g., athlete predictive model 1440.

Once MLA 1420 creates athlete predictive model 1440, test data may be fed into the model to verify the system and test how accurately model 1440 behaves. In some embodiments, test data 1424 is pre-processed to become feature vector(s) 1436 and passed to athlete predictive model 1440 for a prediction. athlete predictive model 1440 examines the input test data, e.g., an available class for a particular athlete (and her profile including prior classes, grades, categories, etc.) and outputs whether a particular class qualifies as recommended. In some embodiments, each iteration of test data 1424 is evaluated and reviewed for accuracy. For example, if expected label 1450 is not correct, false result 1452 may be fed back into MLA 1420 as learning data. If, after test data 1424 is classified and reviewed, model 1440 does not perform as expected (e.g., an error rate below 5%) then additional training data may be provided until the model meets the expected criteria. In some embodiments, a reinforcement learning method may be incorporated with test data to reward or punish MLA 1420.

Once athlete predictive model 1440 works as expected, new real-time data may be fed to the model, and determinations of whether an available class (e.g., a class not yet taken) should be recommended may be predicted with confidence. For instance, in scenario 1400, new athlete data 1430 may pre-processed as feature vector 1436 and passed to athlete predictive model 1440 for a prediction. Athlete predictive model 1440 may evaluate feature vector 1436 and present a label of, e.g., “recommended,” “not recommended,” or neutral for the class-in-question. If new athlete data can be verified outside the system, model 1440 may be further updated with feedback and reinforcement for further accuracy.

Some embodiments may incorporate GPS technology (and related software) to help connect devices by athletes with third parties, and vice versa. For instance, notifications may be presented when a matching athlete or third party is in an area. FIG. 7A-B depict an “Instant Scout” feature than notifies an athlete or recruiter of a presence of a potential match. FIG. 7A depicts a situation of location-based notifications as initiated by an athlete. FIG. 7A depicts a situation of location-based notifications as initiated by a recruiter/coach. In some embodiments, this may be dependent on the respective filters, notification preferences and availability specified by a user and, e.g., at the direction of a user. For instance, a third party may be at an event evaluating talented athletes for future consideration. By enabling a matching mode of some embodiments (running on a GPS-enabled device such as a phone, tablet or computer), a third party can make their presence at the event known to an athlete who concurrently has enabled location detection at their device and noted his/her presence at the event. In some embodiments, each corresponding GPS-enabled device will send a notification for each user to connect with one another. In some embodiments, a device may simply let each user know that an athlete and/or third party was present. The notification may be accompanied with further academic or athletic information of a user—e.g., shared at their discretion—to make the experience of either user much more transparent. For example, the academic and athletic performance of the athlete may be found based on input from athlete 371.

FIG. 8 depicts a diagram of an illustrative ability of a device used to translate a picture to text, in accordance with some embodiments of the disclosure. Some embodiments may incorporate an automated transcript capture feature, e.g., “Pic to Perfect.” For instance, by utilizing a camera-enabled device such as a smartphone or digital camera, Eligibility Wizard may perform (or access), e.g., text recognition (OCR), conversion of a transcript image into text, capture of, e.g., class titles, class grades received, years/dates each class was completed, school(s) attended, years/grade-levels (e.g., Freshman, Sophomore, Junior, Senior) completed, matching transcript information with the NCAA database to only consider the approved courses for input, consideration of any subjective or relational conditions that may alter the credit input per class, submission of gathered information for athlete review, and/or enabling submission(s) by athlete to the engine for processing and output production. Some embodiments may use machine learning and/or artificial intelligence to facilitate such functions. This functionality and machine learning may replace any need for an athlete to input the academic information by hand, e.g., which may be the most difficult and time-consuming part of the eligibility determination process. Reference to Database 376 may or may not be the same as Database 374 used to store an athlete's information (e.g., athlete profile).

Some embodiments may allow connections between people who otherwise may or may not already have a business relationship with one-another. For instance, some embodiments may allow athletes to not only improve their chances of becoming eligible, but also to make it easier for one or several third parties to recruit such an athlete. The initial connection between users must be made by at least one already being a user.

Whether a connection is made with the recipient of such request is a user or non-user at the time will guide some embodiments to utilize various processes to establish a relationship between the users within some embodiments. A main difference between an athlete becoming a user and a third party becoming a user is that an athlete can sign up independently and choose from various packages offered by some embodiments, while the third party must sign up through staff. An athlete can, however, send information, in some embodiments, to a third party independently via any communication medium.

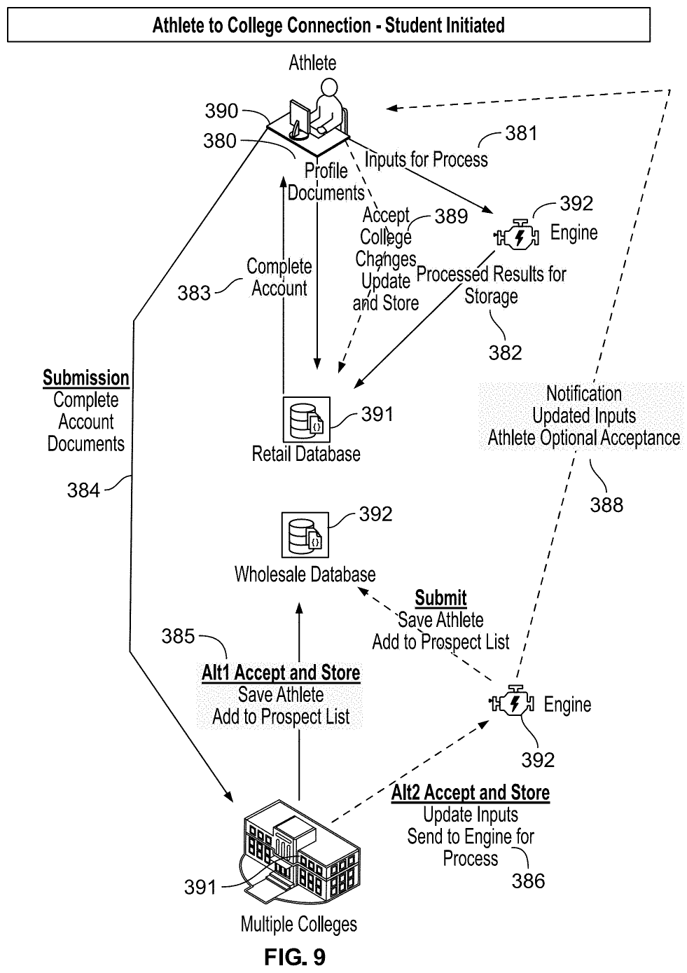

FIG. 9 is a diagram depicting a process of how an athlete who is a user makes a connection with a NCAA college that is also a user. This could happen because an athlete has established a relationship with the third party via in-person encounters where contact information was disseminated or an athlete has a desire to connect with the third party for purposes of subsequently being recruited by the third party. An athlete 389 has signs up with some embodiments to become a user by creating a profile and uploading documents 380 including, but not limited to transcripts and Test Scores. An athlete runs the engine 392 in order to process the output 382 for storage in the retail database 391 for an athlete to interact with 383. An athlete subsequently sends a submission 384 to the third parties 391 desired who can accept and store 385 the information as is or decide to manipulate an athlete's data further 386 by running the engine 392 and saving a modified version of an athlete's output 387 in the wholesale database 392. This means that an athlete has a unique dataset in a retail database but could have one or many datasets as determined by a third party in the wholesale database 392.

Any time a third party edits the data further 386 in the engine 392, an athlete 390 will be notified 388 and can decide to use the third party version of the data 388 to update an athletes unique data by accepting it and sending 389 to the retail database 391 for storage. This is important because different third parties have different experiences interpreting data and may have a different opinion on how the input should be regarded than what an athlete has provided based on their interpretation of their information provided on behalf of an athlete. This process not only educates an athlete, but also serves as a validation check to an athlete who can feel more comfortable the inputs chosen are now more likely to be in alignment with how the NCAA will ultimately interpret the data. The staff will be aware of discrepancies between athlete and third party. Differences in opinion and could potentially update how the engine 392 will handle inputs in similar cases in the future.

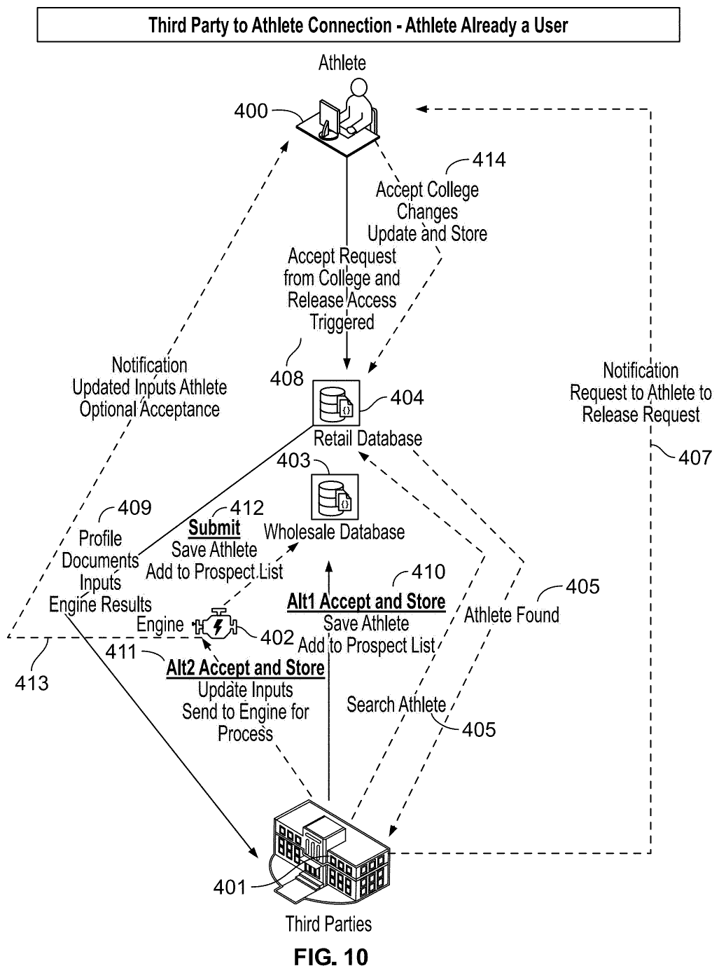

FIG. 10 is a diagram depicting how a third party who is a user can connect with an athlete who is also a user. This would happen when a third party wants to recruit an athlete for athletic purposes and has decided to get involved in the process of helping an athlete become eligible and subsequently enroll in the third party, e.g., an NCAA college. The third party 401 would search 405 for an athlete 400 in the retail database 404. An athlete will be found 406 and the third party 401 will use the connection feature within some embodiments to send a notification request 407 to an athlete 400 that the third party 401 would like to receive all the information available from an athlete 400. An athlete 400 can ignore the request but if the request is accepted 408, the retail database 404 will enable an athlete 400 to provide the information 409 an athlete 400 wants to make available to the third party 401. The third party 401 can either accept the information from an athlete 400 as is by storing it 410 in the wholesale database 403 or it can decide to send the data 411 to the engine 402 for further processing per the third party's 401 interpretation of the inputs to be stored in the wholesale database 404. If the Third party decides to manipulate the inputs received 411, an athlete 400 will receive a notification 407 and an athlete 400 can decide to either disregard the changes and keep the retail database information of an athlete 400 intact or an athlete 400 can accept the changes of a third party 401 by updating information 414 for athlete 400 in the retail database 404.

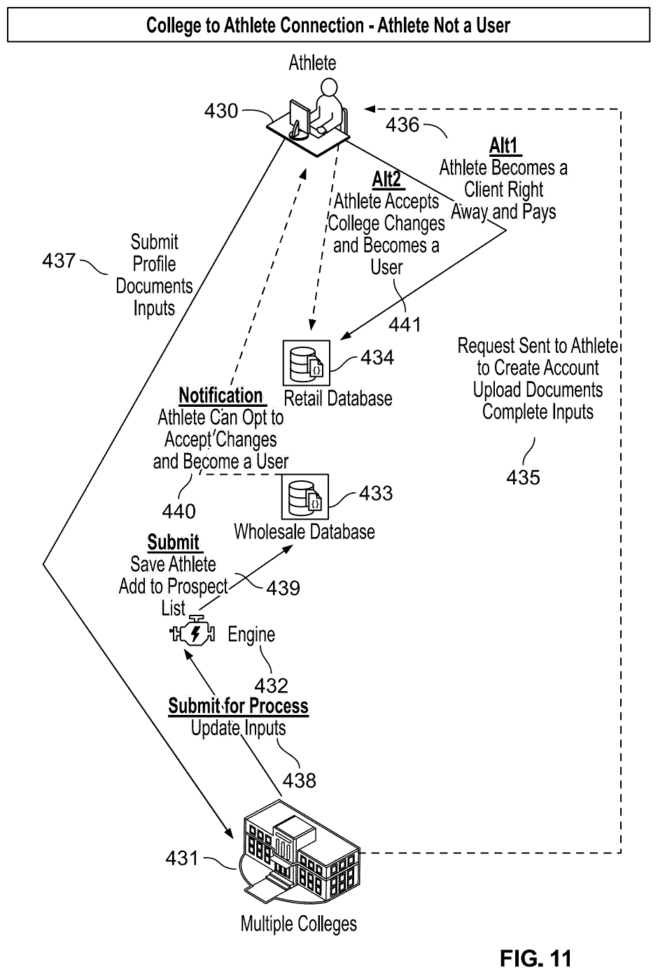

FIG. 11 is a diagram explaining how a third party who is a user can connect with an athlete who is not a user. This would happen when a third party wants to recruit an athlete for athletic purposes and has decided to get involved in the process of helping an athlete become eligible and subsequently enroll in a third party, e.g., an NCAA college. The third party 431 will use the connection feature within some embodiments to send a notification request 435 to athlete 430 via a communication medium including, but not limited to an email account, application etc. The notification from the third party 431 will include instructions to athlete 430 on how to become a user 436 or what information the third party 431 needs from athlete 430 if an athlete declines the invitation to become a user. If an athlete becomes a user, athlete 430 will create an account 436, make payment 436 which is recorded in the retail database 434.

Subsequently athlete 430 submits the desired information 437 requested by the third party 431 in the notification 435 received by athlete 430 to the third party 431. The third party will insert the input on behalf of an athlete 438 and process the desired output using the engine 432 and store an athlete's information in the wholesale database 433. An athlete will automatically receive a notification 440 from the wholesale database 433 that athlete 430 can review the outputs created by the third party 431 and athlete 430 can store the information in the retail database 434 for future review and/or modifications independently.

If athlete 430 chooses to not become a client 436, the difference would be that the third party would receive no information within some embodiments created by an athlete but only documents such as transcripts and Test Scores submitted 437 by athlete 430 using wither an internal communication medium of some embodiments or a communication medium external from some embodiments such as an email for example. Once the wholesale database 433 is updated on behalf of the third party 431 on behalf of athlete 430 the notification 440 to athlete 430 would send a very limited view of an athlete's 430 complete profile within some embodiments with the enticement to unlock the complete version and become a user by completing a profile and submitting a payment 436.

If athlete 430 is a user, athlete 430 is in full control of the information in the retail database and can use it, modify it, distribute it (e.g., externally via email for example or by using a communication feature within some embodiments). If athlete 430 chooses to not become a user, the data on behalf of athlete 430 will only be stored in the wholesale database 433 and only be accessible by the third party exclusively.

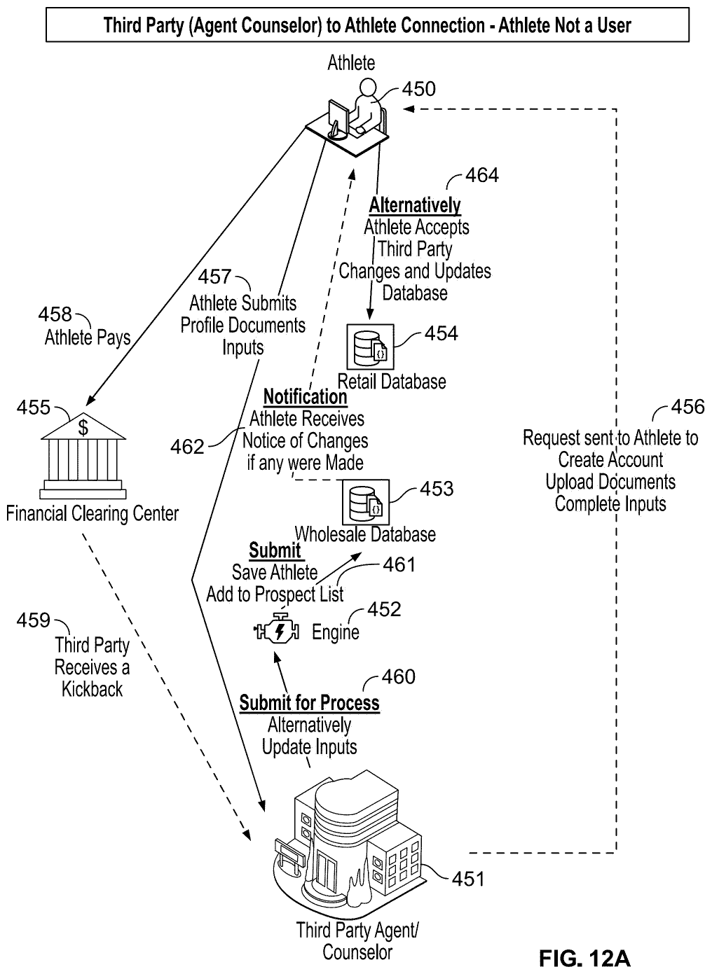

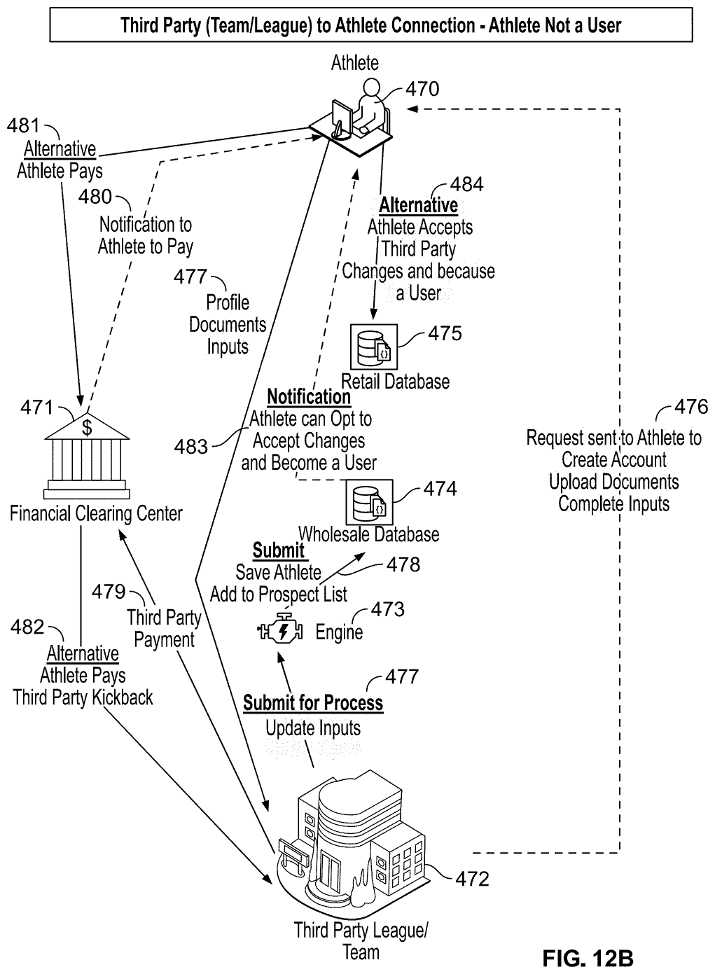

FIG. 12A is a diagram of a connection between a third party 451 who is a user to an athlete 450 who is not a user but the third party 451 is a business entity other than a NCAA college. This third party 451 is any business entity subject to restrictions by NCAA rules explained in FIG. 1B. For example, mismanaging the services without payment from a represented athlete by a third party under this regulation could result in an athlete becoming not eligible. To safeguard against any NCAA rule violations, some embodiments may force a third party subject to the rules under FIG. 1B to mandate a represented athlete to pay for some embodiments in order to become a user.

The third party has the option to receive financial compensation indirectly from an athlete by some embodiments for promoting the usage of some embodiments as long as it complies with the current rules of the NCAA. The third party 451 sends a notification 456 to an athlete 450 it represents who must become a user and pay for the services 458 before sending documents 457 to the third party 451. The third party 451 will provide the input 460 from the documents received from athlete 450 to the engine 452 and the output and all other information of an athlete 450 will be stored in the wholesale database 453. An athlete 450 will receive the completed information 462 and will store the information 464 in the retail database 454. The payment an athlete makes 458 to a financial clearing center 455, such as a bank or similar processing technology used by some embodiments, the third party may or may not receive financial compensation in the form of a kickback 459 which is a percentage of the amount paid 458 by an athlete 450.

FIG. 12B is similar to FIG. 12A in that the third party is not a NCAA program but it is also not subject to any NCAA rules described in FIG. 1B because it does not have an agency relationship with its athletes. This could be a team, league or any other kind of organization providing services to several athletes and may or may not offer to ensure its athletes are going to become eligible. The difference here is that the third party is not providing any athlete services not available to anyone else participating in the team or league. Thus, the status of an athlete being amateur and not professional is intact even though services towards eligibility are provided. The main difference to the diagram in FIG. 12A is the option of the third party or an athlete paying for the services of some embodiments.

The third party, in this case, sends a request 476 to an athlete 470 to become a user. athlete 470 can decide to either pay and become a user and everything in diagram FIG. 12.B would work the same way as FIG. 12.A. However, if athlete 470 chooses not to become a user, the third party may pay on behalf of athlete 470 to make sure the third party 472 does not have athletes in general who become not eligible as it would make the third party 472 lose goodwill value that could constrain its ability to compete in its marketplace. In the case an athlete 470 does not become a user, athlete 470 sends the information 477 requested 476 by the third party 472. A third party may update inputs 477 on behalf of athlete 470 and sends it to engine 473 to be processed and stored 478 in the wholesale database 474. Concurrently the third party makes a payment 479 for usage of some embodiments. Athlete 470 is notified by wholesale database 474 that a completed profile is available 483 and can choose to become a user 484 which would unlock all the features of some embodiments to an athlete who can now access information in a Retail Database. When an athlete becomes a user, a payment is made 481 to Financial Clearing Center 471 and third party 472 may or may not receive a kickback 482.

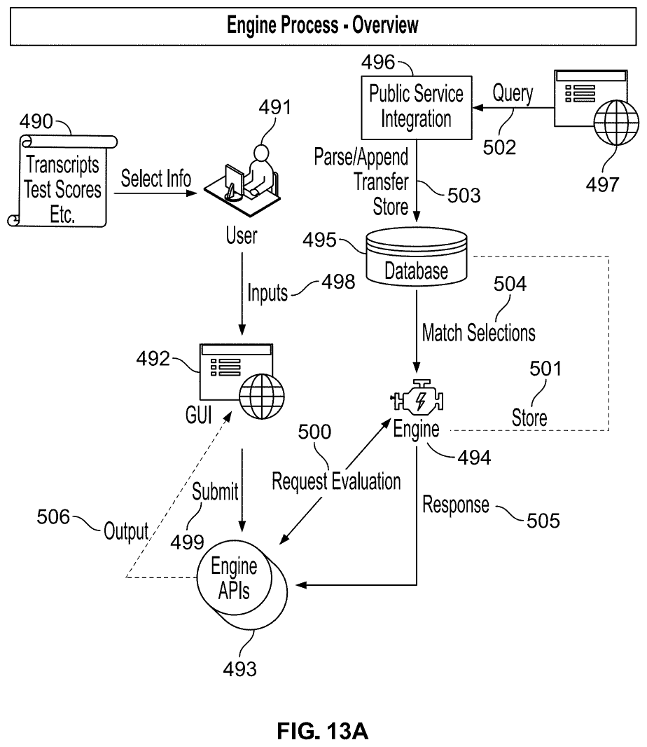

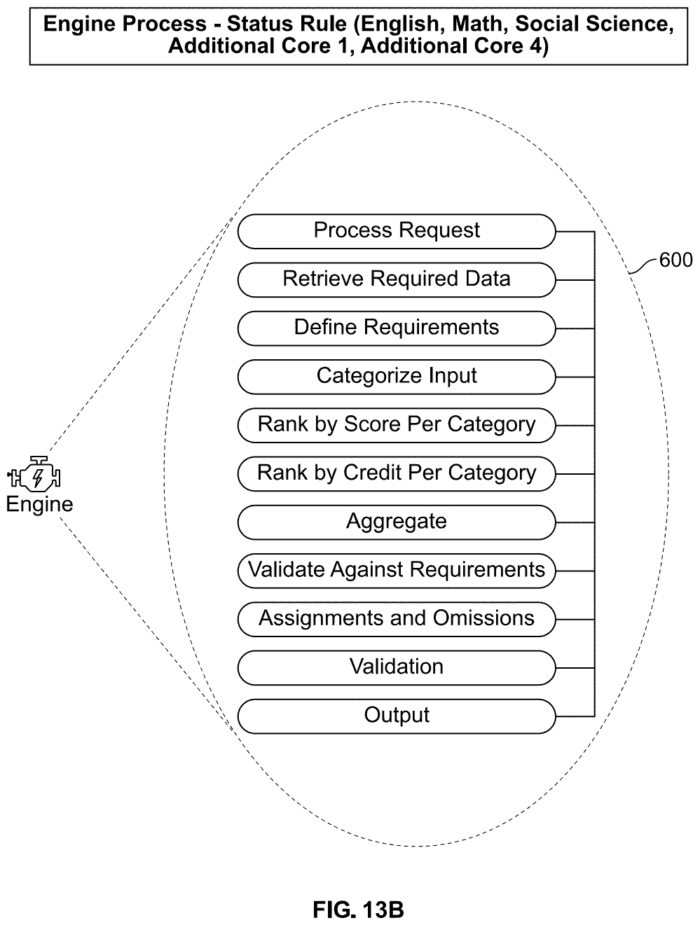

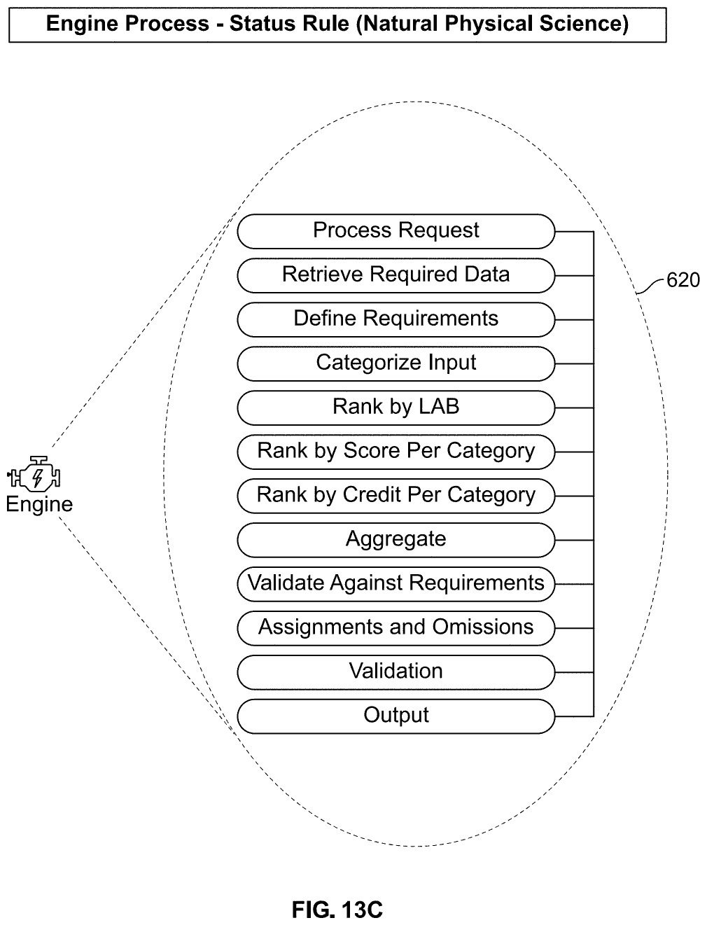

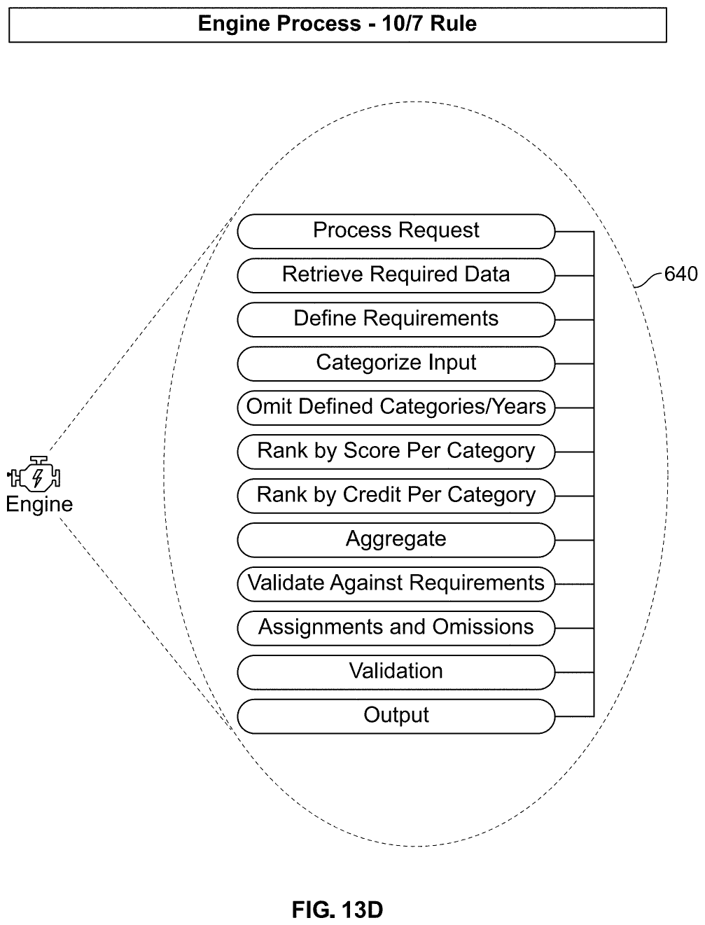

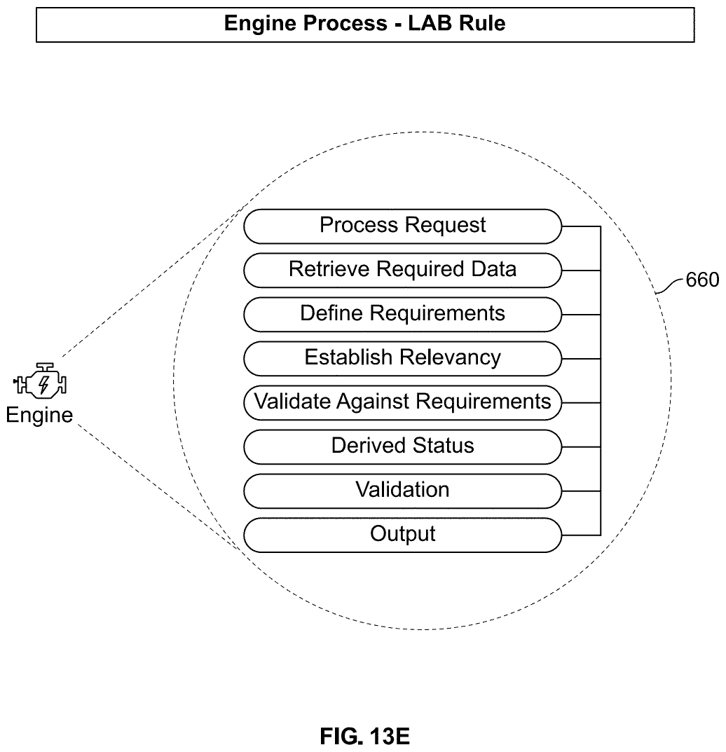

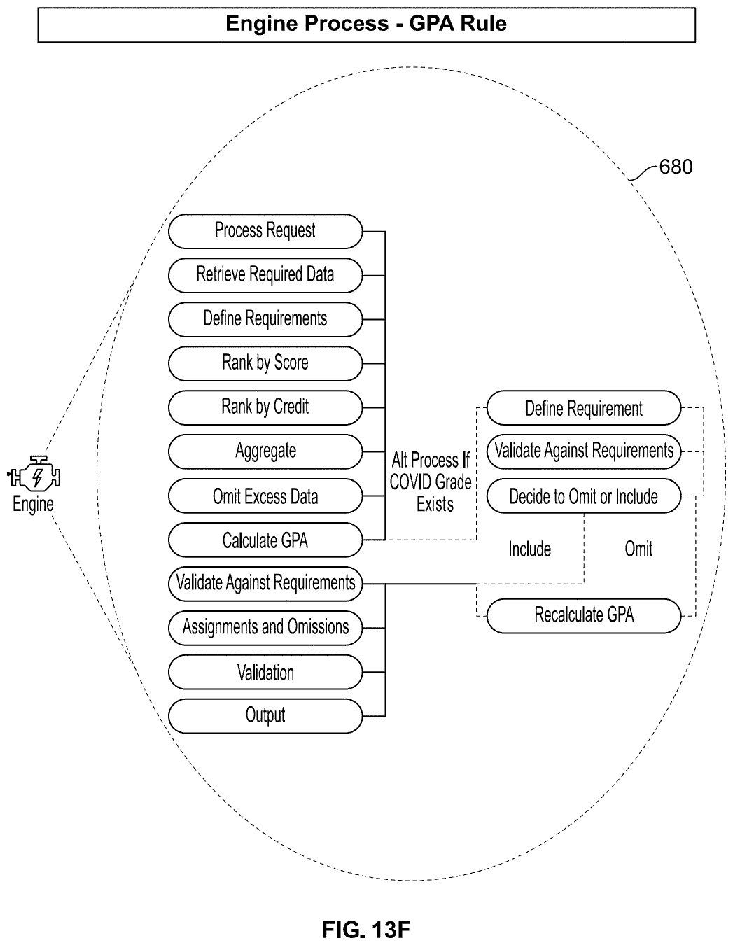

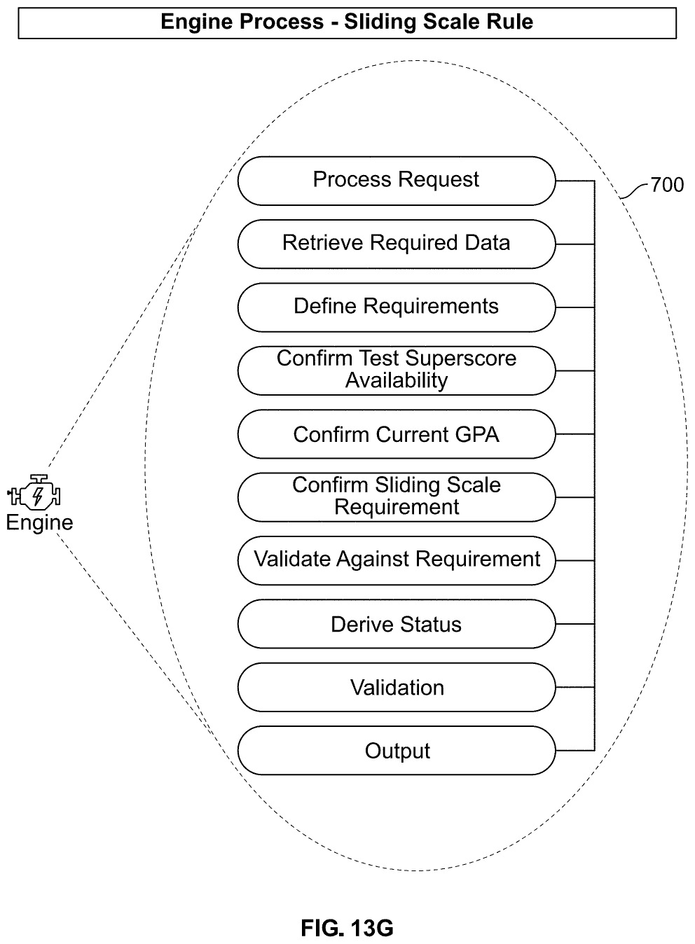

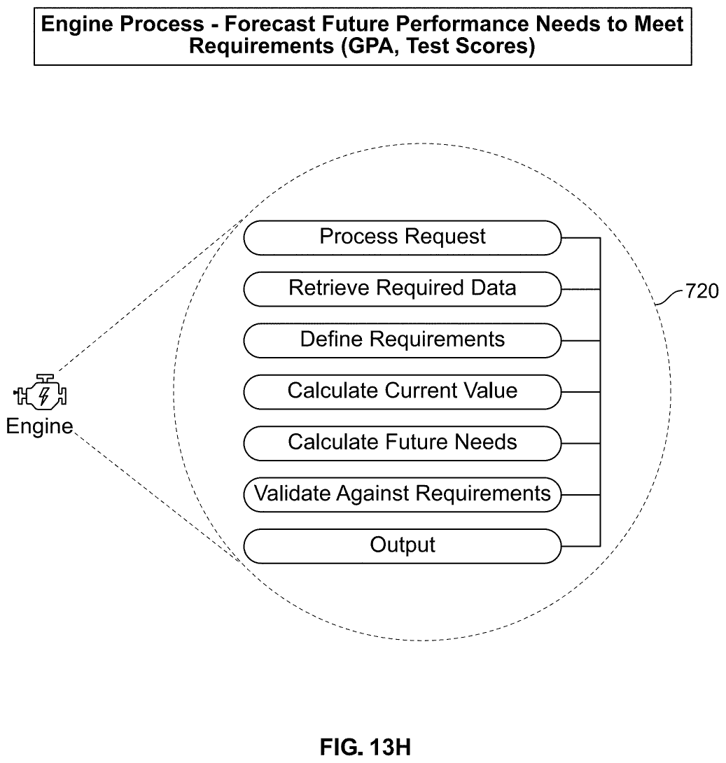

An important component in some embodiment is the engine that, for example, may provide real-time eligibility and goal output to a user. FIG. 13A is a diagram describing an exemplary process of input and output with the engine. Generally, a user will input data, but input could come from a third party who will use a wholesale database or an athlete who will use a retail database. user 491 will use documents 490 to select information available by GUI 492 that is relevant for purposes of eligibility only. Thus, what is on a document may not entirely be needed to achieve eligibility, but some embodiments may make this transparent as all unnecessary information will not be available to a user by some embodiments. The selected information 498 will be submitted 499 to the engine APIs 493 which will request an evaluation 500 from the engine 494. The Response 505 by the engine 494 will be sent back to the engine API 493 and concurrently stored 501 in the database 495. The engine APIs 493 will send the output 506 to the GUI 492 for user 498 review. The database 495 is preloaded with information queried 502 from public information 497 using a public service integration 496 that will parse, append, transfer, store 503 relevant data in the database 495. The database will match the stored 501 information with the information provided to the database 495 by the public service integration 496 in order to validate the request evaluation 500 by the engine APIs 493.

FIG. 13B depicts a process diagram 600 of steps performed by the engine, e.g., when evaluating requests related to the output for English 163, Math 164, Social Science 166, 1 Additional Core 168 and 4 Additional Core 167 (e.g., depicted in FIG. 1). The engine begins by processing the request before retrieving the required data to the process. It defines the requirements of the desired output by categorizing the input by ranking the core per Category before ranking the credit per Category. The engine aggregates the results and validates against the output requirements and makes any necessary assignments or omission's before validating the output for a final result submission.

FIG. 13C depicts a process diagram 620 of steps performed by the engine, e.g., when evaluating requests related to the output for Natural/Physical Science 165. The engine begins by processing the request before retrieving the required data to the process. It defines the requirements of the desired output by categorizing the input by ranking by lab class assignment followed by the score per Category before ranking the credit per Category. The engine aggregates the results and validates against the output requirements and makes any necessary assignments or omission's before validating the output for a final result submission.

FIG. 13D depicts a process diagram 640 of steps performed by the engine, e.g., when evaluating requests related to the output for 10/7 class progress 161. The engine begins by processing the request before retrieving the required data to the process. It defines the requirements of the desired output by categorizing the input by only including the relevant years (e.g., per current rule only the first three years of high school) assignment followed by the score per Category before ranking the credit per Category. The engine aggregates the results and validates against the output requirements and makes any necessary assignments or omission's before validating the output for a final result submission.

FIG. 13E depicts a process diagram 660 of steps performed by the engine, e.g., when evaluating requests related to the output for lab class 169. The engine begins by processing the request before retrieving the required data to the process. It defines the requirements by establishing relevancy (e.g., rule does not apply in certain circumstances) assignment. The engine aggregates the results and validates against the output requirements and makes any necessary assignments or omission's before validating the output for final result submission.

FIG. 13F depicts a process diagram 680 of steps performed by the engine, e.g., when evaluating requests related to the output for the GPA rule 160. The engine begins by processing the request before retrieving the required data to the process. It defines the requirements of the desired output by categorizing the input by ranking the score before ranking the credit per Category. The engine aggregates the results and omits excess data before calculating the GPA. At times, the engine will take further action such as the presence of temporary Grades on a transcript due to a pandemic as occurred in/around years 2020-2021 by a virus referred to as COVID-19. During this time, the NCAA established rules allowing schools to assign temporary scores at the discretion of any high school using such temporary scores on a transcript. In such case, the engine may re-define requirements, validate against the requirements before deciding to include or exclude such temporary grade assignments. If inputs are designated to be excluded, the engine will recalculate the GPA after such exclusions. If grade assignments are to remain included, the engine will not recalculate the GPA but move to validate against requirements immediately. Further necessary assignments or omissions are considered before validating the output for a final result submission.

FIG. 13G depicts a process diagram 700 of steps performed by the engine, e.g., when evaluating requests related to the output for the Sliding Scale rule 162. The engine begins by processing the request before retrieving the required data to the process. It defines the requirements by confirming the availability of SAT and/or ACT test Superscores, and the current GPA, if available. The combination of the Test Scores is compared to the Sliding Scale requirement per the GPA score and the results are confirmed and validated. The rule status is derived and further validated before output.

FIG. 13H depicts a process diagram 720 of a process performed by the engine when evaluating requests related to the output for the Forecast, e.g., FIG. 2 items 180 through and including 184. The engine begins by processing the request before retrieving the required data to the process. It defines the requirements by comparing the necessary score requirements to each of the forecast outputs to the current performance score of an athlete and grabbing the difference between the two. This difference is the numerator divided by remaining units available, if any, to calculate the necessary academic forecast performance of an athlete. The results are confirmed and validated before output.

Some embodiments may allow an athlete to convert SAT scores and/or ACT scores to how the NCAA calculates the data before using it against the Sliding Scale requirement. The current marketplace offers very little guidance as to how this is done. The NCAA also allows Superscores, which makes determining the current status of an athlete who took multiple tests even more confusing. Some embodiments allow each athlete to simply input the overall and component scores to derive the necessary Superscore and subsequent Sliding Scale status and/or requirements.

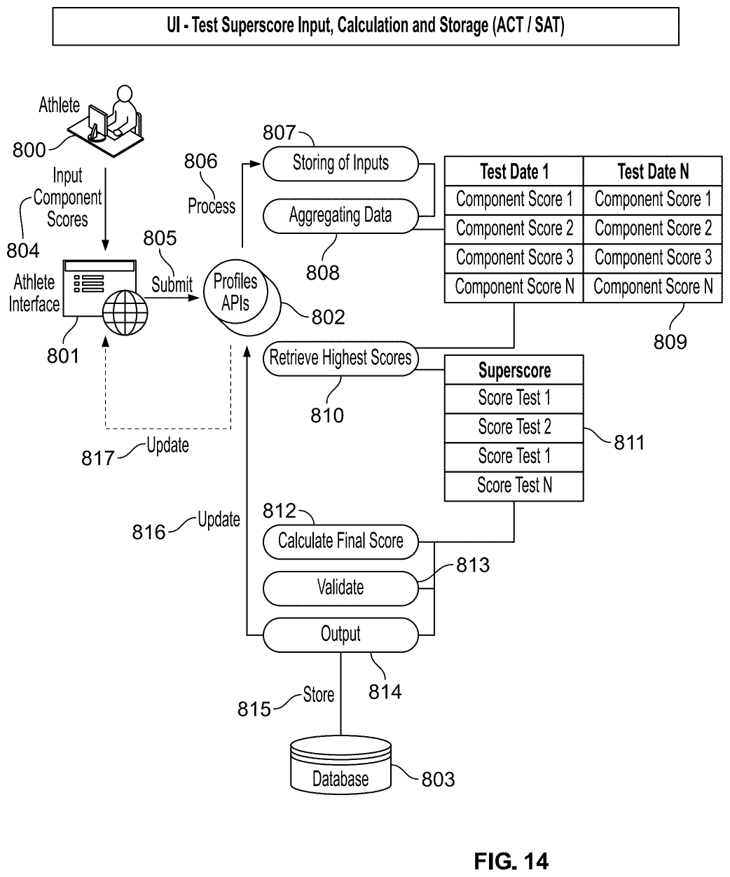

FIG. 14 is a diagram explaining the process from input to output inside some embodiments. An athlete 800 begins by inputting the Test Scores 804 into the GUI 801 which is submitted to the Profile APIs 802. The Profile APIs process 806 the storing of inputs 807 before aggregating the data per test 809. The highest component scores are retrieved 810 to display a Superscore 811 exclusive to each test type including, but not limited to the ACT and SAT. The final score is calculated 812 using the Superscore before validation 813 and output 814 which is stored in the database 803 and updated to the Profile APIs 802. An athlete 800 can access the relevant Superscore 811 in the GUI 801.

One part of some embodiments is the ability to guide athletes to the most suitable NCAA college given their academic performance and preferences. Some athletes only consider the athletic programs at the NCAA colleges they desire but many want to make sure they also get an education that suits their academic preferences. Some embodiments can compare the classes taken and the success of those classes by an athlete along with desires an athlete inputs to some embodiments to gather a “Best Fit” scenario.

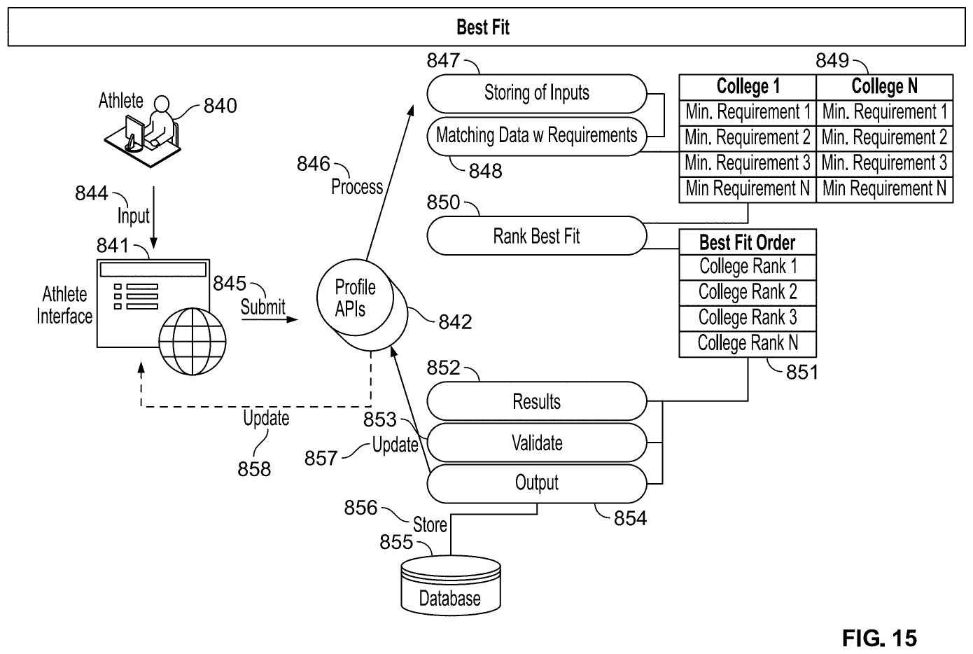

FIG. 15 is a diagram explaining the process from input to output. An athlete 840 starts by providing input 844, such as desired schools, favorite academic subject categories, potential vocational career desires etc. into the GUI 841. These inputs along with the academic performance of an athlete etc. is submitted 845 to the Profile APIs 842 which will process the requests 846 and store the inputs 847. These inputs stored 847 will be matched 848 with the requirements and specialties of the NCAA college's 849. The Best Fit is ranked 850 in order by each College with the Best Fit 851. The results 852 are validated 853 before output 854 which is stored 856 in the database 855 and updated 857 to the Profile APIs 842. The Profile APIs 842 will update 858 the GUI 841 for an athlete 840 to review.

Some embodiments may allow an athlete to designate one or more desired NCAA programs of interest which may or may not have higher athletic performance requirements than the NCAA. This “Goal Setter” feature will replace the NCAA requirements with the higher requirements of each desired NCAA program as additional goals an athlete must meet. Thus, this is not a replacement of any NCAA requirements that apply to everyone but is tailored to the desires of an athlete only.

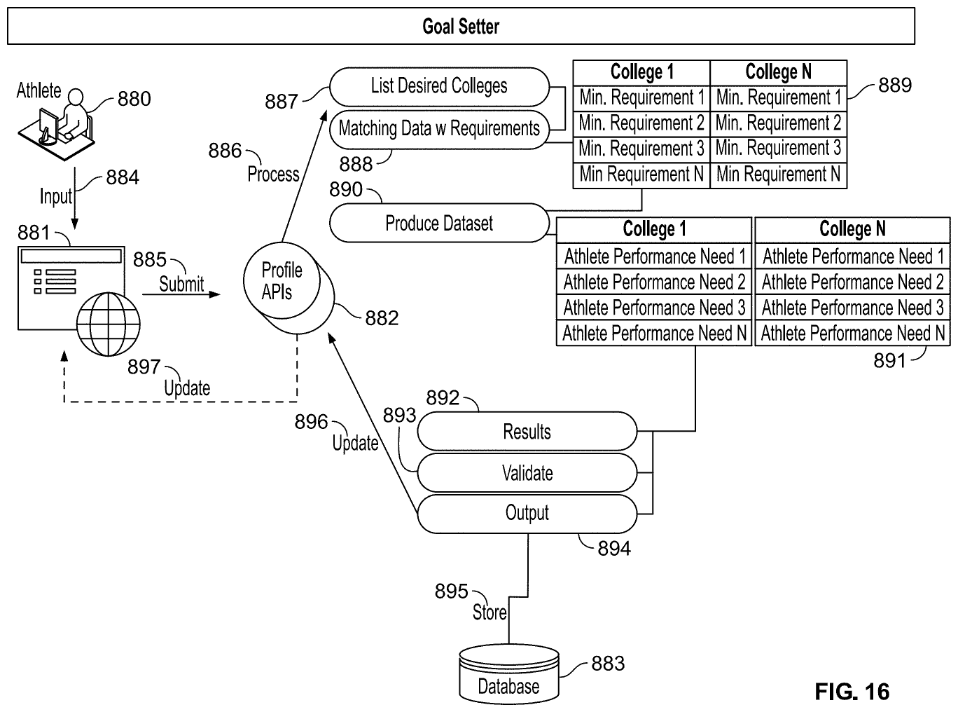

FIG. 16 is a diagram depicting this process. An athlete 880 inputs 884 the desired NCAA colleges to attend into the GUI 881 and submits 885 the final data set to the Profile APIs 882 which will process 886 the data by listing the desired NCAA colleges 887 and matching those NCAA Colleges 887 requirements 888 individually 889 and produce a relevant dataset 890 by NCAA college 891 as a result 892 that is validated 893 before output 894 which is stored 895 in the database 883 and simultaneously updated 896 to the profile APIs 882. The Profile APIs 882 will update 897 the GUI 881 so an athlete 880 can review.

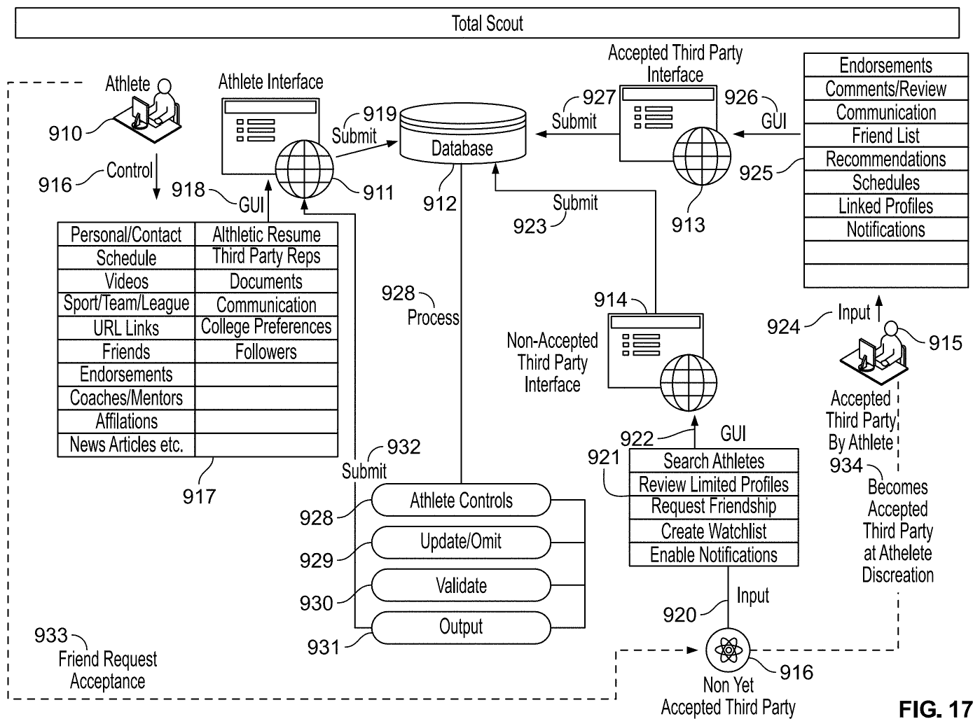

Some embodiments may provide a social media interface to users. FIG. 17 is a diagram explaining the process and available GUI's to users when using some embodiments in this capacity. This is to broaden the scouting profile of an athlete, third party, Team, League, etc. that aims at creating a higher conviction to a user who otherwise would not be convinced to connect with such user. An athlete could, for example, accompany academic achievements produced by some embodiments in terms of eligibility and related documents with demographic traits, athletic accomplishments, videos that exhibit certain qualities, endorsements, communication, additional documents, followers, affiliations and friends to name a few examples. A third party can link its profile to admissions or other staff it may want to streamline to users for connectivity or other information that is important for users to know. There are similar technologies in the marketplace currently such as Facebook, LinkedIn, and Instagram, but such competitors are either business oriented or social network oriented. This part of some embodiments may connect users of special interest which is the recruitment towards the NCAA exclusively. This part of some embodiments may enable communication instantly between athlete's who may seek the same path and/or NCAA colleges for connectivity purposes to discuss various expectations directly. Third parties would benefit from being able to generate a broader perspective of an athlete in lieu of in-person attendance that could convince the third party of an athlete being a strong candidate to become a member of that third party.

users may access media content and the Eligibility Wizard application (and its display screens described above and below) from one or more of their user equipment devices. FIG. 18 shows a generalized embodiment of illustrative user equipment device 1800. More specific implementations of user equipment devices are discussed below in connection with FIG. 19. user equipment device 1800 may receive media content and data via input/output (hereinafter “I/O”) path 1802. I/O path 1802 may provide media content (e.g., broadcast programming, on-demand programming, Internet content, and other video or audio) and data to control circuitry 1804, which includes processing circuitry 1806 and storage 1808. Control circuitry 1804 may be used to send and receive commands, requests, and other suitable data using I/O path 1802. I/O path 1802 may connect control circuitry 1804 (and specifically processing circuitry 1806) to one or more communications paths (described below). I/O functions may be provided by one or more of these communications paths but are shown as a single path in FIG. 18 to avoid overcomplicating the drawing.

Control circuitry 1804 may be based on any suitable processing circuitry 1806 such as processing circuitry based on one or more microprocessors, microcontrollers, digital signal processors, programmable logic devices, etc. In some embodiments, control circuitry 1804 executes instructions for an Eligibility Wizard application stored in memory (i.e., storage 1808). In some client-server-based embodiments, control circuitry 1804 may include communications circuitry suitable for communicating with an application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 19). In addition, communications circuitry may include circuitry that enables peer-to-peer communication of user equipment devices, or communication of user equipment devices in locations remote from each other (e.g., described in more detail below).

Memory (e.g., random-access memory, read-only memory, or any other suitable memory), hard drives, optical drives, or any other suitable fixed or removable storage devices (e.g., DVD recorder, CD recorder, cassette recorder, disk, or other suitable recording device) may be provided as storage 1808 that is part of control circuitry 1804. Storage 1808 may include one or more of the above types of storage devices. For example, user equipment device 1800 may include a solid-state drive and mechanical disk drive or DVD drive as a secondary storage device. Storage 1808 may be used to store various types of media described herein and application data, including program information, application settings, user preferences or profile information, or other data used in operating the application. Nonvolatile memory may also be used (e.g., to launch a boot-up routine and other instructions).

Control circuitry 1804 may include video generating circuitry, one or more MPEG-2 decoders or other digital decoding circuitry, or any other suitable video circuits or combinations of such circuits. The circuitry described herein may be implemented using software running on one or more general purpose or specialized processors. If storage 1808 is provided as a separate device from user equipment 1800, some circuitry may be associated with storage 1808.

A user may control the control circuitry 1804 using user input interface 1810. User input interface 1810 may be any suitable user interface, such as a remote control, mouse, trackball, keypad, keyboard, touch screen, touch pad, stylus input, joystick, voice recognition interface, or other user input interfaces. Display 1812 may be provided as a stand-alone device or integrated with other elements of user equipment device 1800. Display 1812 may be one or more of, e.g., a monitor, a television, a liquid crystal display (LCD) for a mobile device, or any other suitable equipment for displaying visual images. In some embodiments, display 1812 may be high resolution such as 4K or high definition. Speakers 1814 may be provided as integrated with other elements of user equipment device 1800 or may be stand-alone units. The audio component of videos and other media content displayed on display 1812 may be played through speakers 1814. In some embodiments, the audio may be distributed to a receiver (not shown), which processes and outputs the audio via speakers 1814.

The Eligibility Wizard application may be implemented using any suitable architecture. For example, the application may be a client-server-based application. Data for use by a thick or thin client implemented on user equipment device 1800 may be retrieved on-demand by issuing requests to a server remote to the user equipment device 1800. In one example of a client-server-based Eligibility Wizard application, control circuitry 1804 runs a web browser that interprets web pages provided by a remote server. In some embodiments, it may be a stand-alone application wholly implemented on user equipment device 1800. In such an approach, instructions of the application are stored locally, and data for use by the application is downloaded on demand or on a periodic basis.

In some embodiments, the Eligibility Wizard application may be downloaded and interpreted or otherwise run by an interpreter or virtual machine (run by control circuitry 1804). In other embodiments, the Eligibility Wizard application may be defined by a series of JAVA-based files that are received and run by a local virtual machine or other suitable middleware executed by control circuitry 1804.

User equipment device 1800 of FIG. 18 can be implemented in system 1900 of FIG. 19 as user computer equipment 1904, institution computer and server equipment 1902, wireless user communications device 1906, or any other type of user equipment suitable for accessing the internet, such as a portable or non-portable internet-connected device. For simplicity, these devices may be referred to herein collectively as user equipment or user equipment devices. user equipment devices, on which Eligibility Wizard application is implemented, may function as a standalone device or may be part of a network of devices. Various network configurations of devices may be implemented and are discussed in more detail below.

User computer equipment 1904 may include a PC, a laptop, a tablet, a media server, a media center, or other user computer equipment.

Institution computer and server equipment 1902 may include a PC, a laptop, a tablet, a server, or any other network-connected device. Institution computer and server equipment 1902 may be located, for instance, at a college, university, high school, secondary school, governing body, coach/manager's office, or other third-party location.

Wireless user communications device 1906 may be a smartphone, a tablet, e-reader, a PDA, a smartwatch, an activity tracker, speakers/microphones (e.g., with a virtual assistant), a portable video player, a portable music player, a portable gaming device, or other wireless devices.

In system 1900, there is typically more than one of each type of user equipment device but only one of each is shown in FIG. 19 to avoid overcomplicating the drawing. In addition, each user may utilize more than one type of user equipment device (e.g., a user may have a laptop and a PC) and also more than one of each type of user equipment device (e.g., a user may have a smartphone and/or multiple television sets).

The user equipment devices may be coupled to communications network 1914. Namely, user computer equipment 1904, institution computer and server equipment 1902, and wireless user communications device 1906 are coupled to communications network 1914 via communications paths 1910, 1908, and 1912, respectively. Communications network 1914 may be one or more networks including the Internet, a mobile phone network, mobile device network (e.g., 19G/LTE, 5G, etc.), cable network, public switched telephone network, or other types of communications network or combinations of communications networks. Paths 1908, 1910, and 1912 may separately or together include one or more communications paths, such as, an ethernet path, a satellite path, a fiber-optic path, a cable path, a path that supports Internet communications, free-space connections (e.g., for broadcast or other wireless signals), or any other suitable wired or wireless communications path or combination of such paths. Path 1912 is drawn with dotted lines to indicate that in the exemplary embodiment shown in FIG. 19 it is a wireless path and paths 1908 and 1910 are drawn as solid lines to indicate they are wired paths (although these paths may be wireless paths, if desired). Communications with the user equipment devices may be provided by one or more of these communications paths but are shown as a single path in FIG. 19 to avoid overcomplicating the drawing.

Although communications paths are not drawn between user equipment devices, these devices may communicate directly with each other via communication paths, such as those described above in connection with paths 1908, 1910, and 1912, as well other short-range point-to-point communication paths, such as USB cables, wireless paths (e.g., Bluetooth, IEEE 802-11x, etc.), or other short-range communication via wired or wireless paths. The user equipment devices may also communicate with each other directly through an indirect path via communications network 1914.

System 1900 includes profile database 1916 and eligibility requirement database 1918 coupled to communications network 1914 via communication paths 1920 and 1922, respectively. Paths 1920 and 1922 may include any of the communication paths described above in connection with paths 1908, 1910, and 1912. Communications with the profile database 1916 and eligibility requirement database 1918 may be exchanged over one or more communications paths but are shown as a single path in FIG. 19 to avoid overcomplicating the drawing. In addition, there may be more than one of each of profile database 1916 and eligibility requirement database 1918, but only one of each is shown in FIG. 19 to avoid overcomplicating the drawing. The different types of each of these sources are discussed throughout this specification. If desired, profile database 1916 and eligibility requirement database 1918 may be integrated as one source device. Although communications between sources 1916 and 1918 with user equipment devices 1902, 1904, and 1906 are shown as through communications network 1914, in some embodiments, sources 1916 and 1918 may communicate directly with user equipment devices 1902, 1904, and 1906 via communication paths (not shown) such as those described above in connection with paths 1908, 1910, and 1912.

Profile database 1916 may include one or more types of distribution equipment including intermediate distribution facilities and/or servers, Internet providers, on-demand media servers, and other media content providers. Profile database 1916 may be the storage for athlete profiles comprising names, addresses, schools, test scores, classes, grades, credits, categories, location data, calendar data, progress data, athletic metrics, media content (e.g., highlight videos), links to media, preferred schools, and other athlete information. Profile database 1916 may also include user profiles for, e.g., administrators, coaches, scouts, etc. Profile database 1916 may also include a remote server used to store different types of data and content (including athlete video content), in a location remote from any of the user equipment devices. Profile database 1916 may be considered a database or a server facilitating access to one or more databases.

Eligibility requirement database 1918 may provide eligibility data, such as governing body (e.g., NCAA) requirements, rules, regulations, minimum scores, GPAs, sliding scale data, class data, category data, credit data, high school information, grade-weighting data, college descriptions and media, (additional) college requirements, instructions, checklists, help files, how-to videos, and other requirement data. eligibility requirement database 1918 may be in communication with governing bodies and institutions to retrieve and access updates to rules and requirements. In some embodiments, updated rules and requirements may be automatically added to eligibility requirement database 1918. In some embodiments, updated rules and requirements may be manually added to eligibility requirement database 1918. Eligibility requirement database 1918 may be considered a database or a server facilitating access to one or more databases. In some embodiments, eligibility requirement database 1918 may host Eligibility Wizard application.

Eligibility Wizard application data may be provided to the user equipment devices using any suitable approach. For instance, Eligibility Wizard application may be accessible as a web-based application available at, e.g., https://www.eligibilitywizard.com/. User equipment devices may connect to Eligibility Wizard application servers via the cloud (e.g., communications network 1914) and access a web application served by (or in communication with) profile database 1916 and/or eligibility requirement database 1918. In some embodiments, the Eligibility Wizard application may utilize an additional web server to host and/or generate the application GUI.

In some embodiments, Eligibility Wizard applications may be client-server applications where only the client resides on the user equipment device. For example, Eligibility Wizard applications may be implemented partially as a client application on control circuitry 1804 of user equipment device 1800 and partially on a remote server as a server application (e.g., profile database 1916 and/or eligibility requirement database 1918). The application displays may be generated by the profile database 1916 and/or eligibility requirement database 1918 and transmitted to the user equipment devices. In some embodiments, Eligibility Wizard applications may be available for download via third-party application store. Profile database 1916 and/or eligibility requirement database 1918 may also transmit data for storage on the user equipment, which then generates application displays based on instructions processed by control circuitry. In some embodiments, the Eligibility Wizard application may utilize an additional server to host and/or generate application GUI.

In some approaches, eligibility data from eligibility requirement database 1918 may be provided to users' equipment using a client-server approach. For example, an Eligibility Wizard application client residing on the user's equipment may initiate sessions with database 1918 to obtain eligibility data when needed. Eligibility requirement database 1918 may provide user equipment devices 1902, 1904, and 1906 the Eligibility Wizard application itself or software updates for the Eligibility Wizard application.

In some embodiments, Eligibility Wizard applications may be, for example, stand-alone applications implemented on user equipment devices. In some embodiments, the application may be a stand-alone interactive television program guide that receives program guide data via a data feed (e.g., the internet). Profile and eligibility data may be provided to the user equipment with any suitable frequency (e.g., continuously, daily, a user-specified period of time, a system-specified period of time, in response to a request from user equipment, etc.).

System 1900 is intended to illustrate a number of approaches, or network configurations, by which user equipment devices and sources of profile and requirements data may communicate with each other. The present invention may be applied in any one or a subset of these approaches, or in a system employing other approaches for delivering eligibility requirements and storing profiles.

FIGS. 20A-F are decision trees that may be used, e.g., by the NCAA, to establish the NCAA athletic eligibility status at the current time. Such decision trees may change, add decisions, or omit choices in the future. Questions 101, 102, 103 and 104 of FIG. 20A represent the athletic eligibility status 105 or 106 in reference to a “Delayed Enrollment” requirement.

FIG. 20B depicts questions 110, 111, 112, 113, 114, 115, 116 and 117 which represent the athletic eligibility status 118 or 119 in reference to an “Agent Services” requirement.

FIG. 20C depicts questions 120, 121 and 122 which represent the athletic eligibility status 123 or 124 in reference to a “Professional Tryout” requirement.

FIG. 20D depicts questions 130, 131, 132 and 133 represent the athletic eligibility status 134 or 135 in reference to a “Prize Money” requirement as related to men's and women's tennis.

FIG. 20E depicts questions 140, 141 and 142 represent the athletic eligibility status 143 or 144 in reference to a “Prize Money” requirement as related to all sports other than men's and women's tennis.

FIG. 20F depicts a user interface comprising a summary of results 150 that the user provided, along with recommendations 151 that the user should follow. FIG. 30f also depicts an opportunity to check the user's “Academic eligibility” 152.

Specific details in the descriptions and examples provided may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein. Additionally, various components described herein can be a means for performing the operations or functions described in accordance with an embodiment.

While the foregoing discussion describes exemplary embodiments of the present invention, one skilled in the art will recognize from such discussion, the accompanying drawings, and the claims, that various modifications can be made without departing from the spirit and scope of the invention. Therefore, the illustrations and examples herein should be construed in an illustrative, and not a restrictive sense. The scope and spirit of the invention should be measured solely by reference to the claims that follow.

What is claimed is:

1. A computer-implemented method comprising:
storing, in storage equipment, eligibility requirements for athlete candidates from a governing body that at least partially defines an eligibility state;
storing, in the storage equipment, course information from one or more high schools;
receiving, over a communications network, academic information for an athlete candidate;
generating, using processing circuitry, a profile for the athlete candidate using the course information, and the academic information;
determining, using the processing circuitry, a difference in a current state of the athlete candidate and the eligibility state based on the profile;
determining, using the processing circuitry, at least one recommendation for allowing the athlete candidate to achieve the eligibility state; and
providing, over the communications network, the at least one recommendation.

2. The method of claim 1, wherein determining the at least one recommendation comprises using a trained machine learning model to generate data indicative of courses for the athlete candidate to achieve the eligibility state.

3. The method of claim 2, wherein the trained machine learning model generates data indicative of courses for the athlete candidate further based on at least one of the following criteria associated with the athlete candidate: a school, a location, a grade-level, a semester, a sport, and one or more rules associated with the school.

4. The method of claim 2, wherein determining the at least one recommendation comprises using the trained machine learning model to generate data indicative of courses for the athlete candidate to achieve a minimum grade point average.

5. The method of claim 1, wherein determining the at least one recommendation comprises using a data analytics technique to generate data indicative of courses for the athlete candidate to achieve the eligibility state.

6. The method of claim 5, wherein using the data analytics technique comprises processing profiles of a plurality of other students to identify similar profiles of the athlete candidate and to determine which courses taken by students associated with the similar profiles resulted in grades that would help that would achieve the eligibility state.

7. The method of claim 2, wherein the trained machine learning model is trained to receive information about a plurality of completed courses, grades for each of the plurality of completed courses, credits associated with each of plurality of completed, and at least some other information from the profile as input, and output one or more courses that would help achieve a desired grade point average.

8. The method of claim 1, wherein the generating the profile for the athlete candidate further comprises using the eligibility requirements.

9. The method of claim 1 further comprising providing the recommendation and at least a portion of the profile via a wholesale user interface.

10. The method of claim 1, wherein the eligibility requirements further comprise requirements from one or more educational institutions.

11. The method of claim 10 further comprising:
determining whether the athlete candidate meets the requirements from at least one of the one or more educational institutions based on the profile; and
in response to determining the athlete candidate meets the requirements, providing data from the profile to at least one of the one or more educational institutions via a wholesale portal.

12. The method of claim 1, wherein the providing further comprises generating for display a graphical user interface comprising the at least one recommendation in a first section and a portion of the profile in a second section.

13. The method of claim 1, wherein the eligibility requirements further comprise a plurality of standardized test scores each with a corresponding grade point average, the academic information comprises a candidate standardized test score, and determining the at least one recommendation further comprises comparing the candidate standardized test score to the plurality of standardized test scores.

14. A system comprising:
non-transitory memory configured to:
store eligibility requirements for athlete candidates from a governing body that defines an eligibility state;
storing, in the storage equipment, course information from one or more high schools;
a network adapter configured to receive, over a communications network, academic information for an athlete candidate;
processing circuitry configured to:
generate a profile for the athlete candidate using the course information, and the academic information;
determine a difference in a current state of the athlete candidate and the eligibility state based on the profile;
determine at least one recommendation for allowing the athlete candidate to achieve the eligibility state; and
provide the at least one recommendation.

15. The system of claim 14, wherein the processing circuitry is further configured to determine the at least one recommendation comprises using a trained machine learning model to generate data indicative of courses for the athlete candidate to achieve the eligibility state.

16. The system of claim 15, wherein the trained machine learning model generates data indicative of courses for the athlete candidate further based on at least one of the following criteria associated with the athlete candidate: a school, a location, a grade-level, a semester, a sport, and one or more rules associated with the school.

17. The system of claim 15, wherein the processing circuitry is further configured to determine the at least one recommendation comprises using the trained machine learning model to generate data indicative of courses for the athlete candidate to achieve a minimum grade point average.

18. The system of claim 14, wherein the processing circuitry is further configured to determine the at least one recommendation comprises using a data analytics technique to generate data indicative of courses for the athlete candidate to achieve the eligibility state.

19. The system of claim 18, wherein the processing circuitry is further configured to use the data analytics technique by processing profiles of a plurality of other students to identify similar profiles of the athlete candidate and to determine which courses taken by students associated with the similar profiles resulted in grades that would help that would achieve the eligibility state.

20. The system of claim 15, wherein the trained machine learning model is trained to receive information about a plurality of completed courses, grades for each of the plurality of completed courses, credits associated with each of plurality of completed, and at least some other information from the profile as input, and output one or more courses that would help achieve a desired grade point average.

21. The system of claim 14, wherein the processing circuitry is further configured to generate the profile for the athlete candidate using the eligibility requirements.

22. The system of claim 14, wherein the processing circuitry is further configured to provide the recommendation and at least a portion of the profile via a wholesale user interface.

23. The system of claim 14, wherein the eligibility requirements further comprise requirements from one or more educational institutions.

24. The system of claim 23, wherein the processing circuitry is further configured to:
determine whether the athlete candidate meets the requirements from at least one of the one or more educational institutions based on the profile; and
in response to determining the athlete candidate meets the requirements, provide data from the profile to at least one of the one or more educational institutions via a wholesale portal.

25. The system of claim 14, wherein the processing circuitry is further configured to generate for display a graphical user interface comprising the at least one recommendation in a first section and a portion of the profile in a second section.

26. The system of claim 14, wherein the eligibility requirements further comprise a plurality of standardized test scores each with a corresponding grade point average, the academic information comprises a candidate standardized test score, and wherein the processing circuitry is further configured to determine the at least one recommendation by comparing the candidate standardized test score to the plurality of standardized test scores.

27. A non-transitory computer-readable medium having instructions encoded thereon that when executed by control circuitry cause the control circuitry to:
store, in storage equipment, eligibility requirements for athlete candidates from a governing body that defines an eligibility state;
store, in the storage equipment, course information from one or more high schools;
receive, over a communications network, academic information for an athlete candidate;
generate, using processing circuitry, a profile for the athlete candidate using the course information, and the academic information;
determine a difference in a current state of the athlete candidate and the eligibility state based on the profile;
determine at least one recommendation for allowing the athlete candidate to achieve the eligibility state; and
provide, over the communications network, the at least one recommendation.

28. The non-transitory computer-readable medium of claim 27, wherein the instructions further cause the control circuitry to determine the at least one recommendation using a trained machine learning model to generate data indicative of courses for the athlete candidate to achieve the eligibility state.

29. The non-transitory computer-readable medium of claim 28, wherein the trained machine learning model generates data indicative of courses for the athlete candidate further based on at least one of the following criteria associated with the athlete candidate: a school, a location, a grade-level, a semester, a sport, and one or more rules associated with the school.

30. The non-transitory computer-readable medium of claim 28, wherein the instructions further cause the control circuitry to determine the at least one recommendation using the trained machine learning model to generate data indicative of courses for the athlete candidate to achieve a minimum grade point average.

31. The non-transitory computer-readable medium of claim 27, wherein the instructions further cause the control circuitry to determine the at least one recommendation using a data analytics technique to generate data indicative of courses for the athlete candidate to achieve the eligibility state.

32. The non-transitory computer-readable medium of claim 31, wherein the instructions further cause the control circuitry to use the data analytics technique by processing profiles of a plurality of other students to identify similar profiles of the athlete candidate and to determine which courses taken by students associated with the similar profiles resulted in grades that would help that would achieve the eligibility state.

33. The non-transitory computer-readable medium of claim 28, wherein the trained machine learning model is trained to receive information about a plurality of completed courses, grades for each of the plurality of completed courses, credits associated with each of plurality of completed, and at least some other information from the profile as input, and output one or more courses that would help achieve a desired grade point average.

34. The non-transitory computer-readable medium of claim 27, wherein the instructions further cause the control circuitry to generate the profile for the athlete candidate using the eligibility requirements.

35. The non-transitory computer-readable medium of claim 27, wherein the instructions further cause the control circuitry to provide the recommendation and at least a portion of the profile via a wholesale user interface.

36. The non-transitory computer-readable medium of claim 27, wherein the eligibility requirements further comprise requirements from one or more educational institutions.

37. The non-transitory computer-readable medium of claim 36, wherein the instructions further cause the control circuitry to:
determine whether the athlete candidate meets the requirements from at least one of the one or more educational institutions based on the profile; and
in response to determining the athlete candidate meets the requirements, provide data from the profile to at least one of the one or more educational institutions via a wholesale portal.

38. The non-transitory computer-readable medium of claim 27, wherein the instructions further cause the control circuitry to generate for display a graphical user interface comprising the at least one recommendation in a first section and a portion of the profile in a second section.

39. The non-transitory computer-readable medium of claim 27, wherein the eligibility requirements further comprise a plurality of standardized test scores each with a corresponding grade point average, the academic information comprises a candidate standardized test score, and wherein the instructions further cause the control circuitry to determine the at least one recommendation by comparing the candidate standardized test score to the plurality of standardized test scores.
